(19) United States
(12) Patent Application Publication
(10) Pub. No.: US 2022/0380604 A1
(43) Pub. Date: Dec. 1, 2022

(54) SURFACE MODIFIED KAOLIN PIGMENT AND METHOD THEREOF

(71) Applicant: BASF Corporation, Florham Park, NJ (US)

(72) Inventors: Wilson Wanene KAMAU, Warner Robins (US); Sharad MATHUR, Tega Cay (US); Ashok KHOKHANI, Manalapan (US); James Robert GODFREY, Tennille (US)

(21) Appl. No.: 17/624,054

(22) PCT Filed: Jun. 30, 2020
(86) PCT No.: PCT/US2020/040343

§ 371 Date: Dec. 30, 2021

Related U.S. Application Data
(60) Provisional application No. 62/869,397, filed on Jul. 1, 2019.

(51) Int. Cl. C09C 1/42; C09C 3/12; C09C 3/10; C09C 3/00; C09D 7/20; C09D 7/62; C09D 5/02

(52) U.S. Cl. CPC C09C 1/42; C09C 3/12; C09C 3/10; C09C 3/006; C09D 7/20; C09D 7/62; C09D 5/022

(57) ABSTRACT

Provided herein are surface treated pigments and methods of making and using the surface treated pigments. The surface treated pigments can comprise a mineral pigment surface treated with a hydrophilic latex composition and a hydrophobic material, which produce a film on an outer surface of the pigment. The hydrophobic material can be selected from a silane, a siloxane, or a siloxane/silicone resin blend, wax, fatty acid, styrene-butadiene latex, or a mixture thereof. The hydrophilic latex composition can be selected from a straight (meth)acrylic latex emulsion, a styrene-(meth)acrylic latex emulsion, or a blend thereof. The surface treated pigment has a surface energy that is less than a surface energy of the mineral pigment alone, a water contact angle of at least 90° and a dodecane contact angle of less than 150°.

### FIELD OF THE DISCLOSURE

The present disclosure relates to surface modified pigments, particularly to pigments modified with a hydrophilic composition and a hydrophobic material.

### BACKGROUND

Coatings typically include one or more pigments, binders, and solvents. Pigments include granular solids and/or minerals and are incorporated into the coatings to influence properties such as color, toughness, texture, and/or to act as an extender. One characteristics of coatings that are often desirable is stain or dirt resistance. Stain resistance relates to the resistance of a dry coating film to be stained in a manner in which the stain cannot be cleaned from the film. Other characteristics such as scrub resistance and barrier properties including solvent and water barrier properties are also desirable for many common coatings, such as in paints, where it may often be more desirable to clean a painted surface than to repaint the surface. It is desirable to provide pigments for use in coatings that improve stain resistance in a cost-effective manner.

Pigments used in coatings are mostly inorganic in nature and are generally formed from minerals such as titanium dioxide, clay such as kaolin, mica, talc, silica, silicates, feldspars, or calcium carbonate. However, many mineral pigments do not disperse well in coating systems. This problem affects both the formulation and storage of the coating compositions and the appearance of the finished coating. In formulating aqueous coating compositions, for example, often special processing considerations must be given to insuring the uniform incorporation of pigments to avoid aggregation of the particles. It is desirable to provide pigments for use in coatings that are easily dispersible in the coatings.

The compositions and methods described herein address these and other needs.

### SUMMARY OF THE DISCLOSURE

Disclosed herein are surface treated pigments and methods of making and using the surface treated pigments. The surface treated pigments can comprise a mineral pigment surface treated with a hydrophilic latex composition and a hydrophobic material, which produce a film on an outer surface of the mineral pigment. The mineral pigment can be selected from the group consisting of kaolin, bentonite, mica, talc, attapulgite, silica, calcium carbonate, halloysite, wollastonite, nepheline syenite, feldspar, diatomaceous earth, and zeolite. In some cases, the mineral pigment can be calcined prior to surface treatment. The mineral pigment preferably includes kaolin, more preferably calcined kaolin. The mineral pigment has an average particle size of less than 10 microns, such as ranging from 0.1 to 10 microns or from 0.1 to 2 microns.

The hydrophobic material used to surface treat the mineral pigment can be selected from a silane, a siloxane, or a siloxane/silicone resin blend, wax, fatty acid, styrene-butadiene latex, or a mixture thereof. In some embodiments, the hydrophobic material includes an organosilane monomer having a structure defined by the general Formula I below:

(R¹)—(Si)—(R²)₃ (I)

wherein R¹ is a C₁-C₈ substituted or unsubstituted alkyl or a C₂-C₈ substituted or unsubstituted alkene and each of R² is independently a C₁-C₈ substituted or unsubstituted alkyl group, a C₁-C₈ substituted or unsubstituted alkoxy group, or a combination thereof. In other embodiments, the hydrophobic material includes an oligomeric or polymeric siloxane. Specific examples of hydrophobic materials include vinyltrimethoxysilane, vinyltriethoxysilane, vinyl tris(2-methoxyethoxy silane), vinyl triisopropoxysilane, gamma-methacryloxypropyl trimethoxysilane, (3-methacryloxypropyl)-trimethoxysilane, (3-methacryloxypropyl)-triethoxysilane, (3-methacryloxypropyl)-triisopropoxysilane, 2-methyl-2-propenoic acid 3-[tris-(1-methylethoxy)-silyl]-propyl ester, (3-methacryloxypropyl)-methyldiethoxysilane, 3-glycidoxypropyl methyldiethoxysilane, 3-glycidoxypropyl methyldimethoxysilane, oligomers thereof, polymers thereof, or combinations thereof.

The hydrophilic latex composition can be selected from a straight (meth)acrylic latex emulsion, a styrene-(meth)acrylic latex emulsion, or a blend thereof. In some examples, the hydrophilic latex composition comprises a straight (meth)acrylic latex emulsion. The straight (meth)acrylic latex emulsion can include a polymer derived from 80% or greater, preferably from 80% to less than 100% by weight of a (meth)acrylate monomer. In other examples, the hydrophilic latex composition comprises a styrene-(meth)acrylic latex emulsion. The styrene-(meth)acrylic latex emulsion can comprise a copolymer derived from 20% to 80% by weight of styrene and 20% to 80% by weight of a (meth)acrylate monomer. The straight (meth)acrylic latex emulsion or the styrene-(meth)acrylic latex emulsion can be further derived from one or more additional monomers that include carboxylic acid monomers, crosslinkable functional monomers, (meth)acrylamide, or mixtures thereof. The polymer present in the straight (meth)acrylic latex emulsion or the styrene-(meth)acrylic latex emulsion can have a glass transition temperature of 30° C. or less, preferably from −60° C. to 30° C., more preferably from −40° C. to less than 0° C.

As disclosed herein, the mineral pigment is surface treated with a hydrophilic latex composition and a hydrophobic material. In specific examples, the mineral pigment can be surface treated with a straight (meth)acrylic latex emulsion as the hydrophilic latex composition and a silane as the hydrophobic material. The hydrophilic latex composition and the hydrophobic material can be in a weight ratio of from 1:4 to 4:1, from 1:3 to 3:1, preferably from 1:2 to 2:1. The surface treated pigment can comprise 0.2% by weight or greater, preferably from 0.2% to 5% by weight, more preferably from 0.5% to 2% by weight of the hydrophilic latex composition and the hydrophobic material, based on the weight of the surface treated pigment.

The surface treated pigment has a surface energy that is less than a surface energy of the mineral pigment alone. The difference between the surface energy of the surface treated pigment and that of the mineral pigment can be 1 mN/m or greater, or from 1 mN/m to 5 mN/m. The surface energy of the surface treated pigment may also be less than the surface energy of the mineral pigment treated with the hydrophilic latex composition alone. For example, the difference between the surface energy of the surface treated pigment and that of the mineral pigment treated with the hydrophilic latex composition alone can be 0.2 mN/m or greater, or from 0.2 mN/m to 2 mN/m. In further embodiments, the surface energy of the surface treated pigment may be less than the surface energy of a mineral pigment treated with the hydrophobic material alone. For example, the difference between the surface energy of the surface treated pigment and that of the mineral pigment treated with the hydrophobic material alone can be 0.2 mN/m or greater, or from 0.2 mN/m to 2 mN/m. Overall, the surface treated pigment can have a surface energy of less than 20 mN/m, such as from 10 to 18 mN/m.

The surface of the surface treated pigment may exhibit a water contact angle of at least 90° and a dodecane contact angle of less than 150°. Both the water contact angle and the dodecane contact angle of the surface treated pigment may be higher than the water contact angle and dodecane contact angle of the mineral pigment. Also, both the water contact angle and the dodecane contact angle of the surface treated pigment may be higher than the water contact angle and dodecane contact angle of the mineral pigment treated with the hydrophobic material alone. In some cases, the water contact angle of the surface treated pigment is less than the water contact angle of the mineral pigment treated with the hydrophilic latex composition alone and the dodecane contact angle of the surface treated pigment is greater than a dodecane contact angle of a mineral pigment treated with the hydrophilic latex composition alone.

The surface treated pigment may be less wettable by water, compared to the mineral pigment or a mineral pigment treated with the hydrophilic latex composition alone, as determined by ASTM 7315-17. In general, the turbidity of a mixture comprising water and the surface treated pigment increases with increased wettability of the surface treated pigment. In some embodiments, a mixture comprising the surface treated pigment in contact with water for a period of at least 120 minutes, can exhibit a turbidity of 1.5 NTU or less, 1.0 NTU or less, or from 0.2 to 1.5 NTU.

Methods of producing the surface treated pigments are also disclosed. The methods can include mixing a mineral pigment with a hydrophilic latex composition and a hydrophobic material under conditions to surface treat the mineral pigment. The mineral pigment can be mixed in a dry form such as a powder or as a slurry. When mixed as a slurry, the slurry is dried by heating after mixing with the hydrophilic latex composition and/or the hydrophobic material. The hydrophobic material can be provided as a neat material, such as a neat silane, a neat siloxane, or a mixture thereof. In other embodiments, the hydrophobic material can be provided as a mixture such as a silane emulsion, a siloxane emulsion, or a mixture thereof.

The hydrophilic latex composition and the hydrophobic material can be blended prior to mixing with the mineral pigment. Alternately, the hydrophilic latex composition and the hydrophobic material can be mixed with the mineral pigment sequentially. Mixing can be carried out with a blender or a centrifuge for at least 30 minutes.

Aqueous coating systems comprising the surface treated pigments are also disclosed herein. The aqueous coating systems can comprise at least 0.2% by weight, such as from 0.2% to 30% by weight, or from 0.5% to 10% by weight of the surface treated pigment. The aqueous coating systems further comprise a polymer binder system, which may include a latex polymer binder.

The polymer binder system can be present in an amount of at least 10% by weight, preferably from 10% to 99% by weight, more preferably from 10% to 95% by weight, based on the weight of the aqueous coating system. Suitable latex polymer binders include a polymer derived from synthetic resins, natural resins, (meth)acrylics, polyurethanes, polyesters including unsaturated and saturated polyesters, melamine polymers, epoxy polymers, alkyds, phenolic polymers, ureaformaldehyde polymers, polyalkylenes including polyethylenes and polypropylenes, polystyrenes, polyamides, polyvinyl compounds, polyisoprenes, polybutadienes, polystyrene butadienes, or a combination thereof. The aqueous coating system can further include an untreated mineral pigment. For example, the aqueous coating system can include an untreated mineral pigment selected from titanium dioxide, clay, kaolin, mica, talc, natural silica, synthetic silica, natural silicates, synthetic silicates, feldspars, nepheline syenite, wollastonite, diatomite, barite, glass, calcium carbonate, or combinations thereof.

The aqueous coating system can be in the form of a paint, an ink, or an adhesive optionally and applied to a substrate. Suitable substrates include a fabric, a fiber, a carpet, a concrete, a wood, a vinyl, a leather, a metal, a plastic, a ceramic, or a paper.

Treated films having a thickness of at least 0.5 microns, such as from 0.5-150 microns can be formed from the aqueous coating systems and may exhibit stain and/or dirt resistance properties. Stain and/or dirt can produce an observable color change on a film. In some embodiments, the color of the stain and/or dirt on the treated film is reduced by a ΔE value of 0.1 or greater, greater than 0.1, or greater than 0.2 compared to an identical film formed from the untreated pigment, as determined by ASTM D2244-16. In some embodiments, the treated film can exhibit a total color change value, ΔE, of from 0 to less than 10, or from 0 to less than 5, after 1 hour of contact with the stain and/or dirt, as determined by ASTM D2244-16. In some instances, the treated films exhibit stain resistance properties to both hydrophobic and hydrophilic stains. For example, the treated films may exhibit resistance to coffee stains, mustard stains, ketchup stains, lipstick stains, ink stains, juice stains, wine stains, or combinations thereof. In further instances, the treated film may exhibit oil barrier properties, water barrier properties, oil and water barrier properties, and/or solvent barrier properties, as determined by ASTM D 4828-94.

Methods for improving the stain and/or dirt resistance properties of a surface comprising applying an aqueous coating system to the surface are disclosed herein. The surface can be a fabric, a fiber, a carpet, a concrete, a wood, a vinyl, a leather, a metal, a plastic, a ceramic, or a paper.

The details of one or more embodiments are set forth in the description below. Other features, objects, and advantages will be apparent from the description and from the claims.

### DETAILED DESCRIPTION

Disclosed herein are surface treated pigments comprising a mineral pigment surface treated with a hydrophilic latex composition and a hydrophobic material. At least one of the hydrophilic latex composition and the hydrophobic material produces a film on an outer surface of the mineral pigment. The surface treated pigment has a surface energy that is less than a surface energy of the mineral pigment alone.

Surface Treated Mineral Pigments

Surface treated pigments including at least one mineral pigment surface treated with a hydrophilic latex composition and a hydrophobic material are disclosed. The terms “surface treated” or “surface treatment” as used herein refer to a chemically or physically modified surface. The term “hydrophilic” refers to a material that is wettable by aqueous compositions (e.g., water or latex dispersions) in contact with the material. As such, the term “hydrophilic” can be used interchangeably with the term “wettable.” Hydrophilicity and wettability can be defined in terms of contact angle and the surface tension of the materials involved. A material, for example a pigment surface, is said to be wetted by water (i.e., hydrophilic) when either the contact angle between the water and the pigment surface is less than 90°, or when the water tends to spread spontaneously across the surface of the pigment, both conditions normally coexisting. In general, the lower the contact angle between the surface and the water, the more hydrophilic the surface. The hydrophilic latex compositions described herein generally has good affinity to water or an aqueous liquid.

The term “hydrophobic” refers to a material that is resistant to wetting or not readily wet, by aqueous liquids (e.g., water or aqueous dispersions). That is, the material has little or a lack of affinity for aqueous liquids deposited on the surface. “Hydrophobicity” can be defined in terms of contact angle and the surface tension of the materials involved. A material, for example a pigment surface, is said to be hydrophobic (little or no affinity for water or not wettable) when either the contact angle between the water and the pigment surface is greater than 90°, or when the water tends to repel (does not spread spontaneously) across the surface of the pigment, both conditions normally coexisting. In general, the higher the contact angle between the surface and the water, the more hydrophobic the surface. The hydrophobic materials described herein are not wettable and has little or lack affinity to water.

As described herein, a material, for example a pigment surface, is regarded as wettable by an aqueous liquid if it yields a contact angle with the aqueous liquid less than 90°. However, a surface treated pigment might not be wettable by an aqueous liquid even if the individual treatment (such as a hydrophilic latex composition) exhibits a water contact angle less than 90°. This is due to the fact that the surface of the surface treated pigment includes a combination of hydrophilic and hydrophobic material. Further, the contact angle of the surface treated pigment can be the weighted average of the contact angles of the hydrophilic material (<90°), the hydrophobic material (>90°), and the untreated mineral pigment. The specific surface treatment and the mineral pigment therefore affect wettability.

Hydrophilic Treatments

As described herein, the mineral pigments are surface treated with at least one hydrophilic material. The hydrophilic material can be formed from a latex composition. The latex composition can be an aqueous latex dispersion. In some embodiments, the hydrophilic latex composition can include a polymer derived from (meth)acrylate monomers, (meth)acrylic acid monomers, ethylenically-unsaturated monomers including vinyl aromatic monomers (e.g., styrene), vinyl ester monomers (e.g., vinyl acetate), and combinations thereof. In some embodiments, the polymer can be derived from an acrylic-based latex (i.e., a polymer derived from one or more (meth)acrylate and/or (meth)acrylic acid monomers including straight acrylic latex homopolymers), a vinyl aromatic-acrylic copolymer (i.e., a polymer derived from vinyl aromatic monomers such as styrene and one or more (meth)acrylate and/or (meth)acrylic acid monomers), or a combination thereof.

In some embodiments, the hydrophilic latex composition can include a (meth)acrylic-based polymer. For example, the hydrophilic latex composition can include a polymer derived from one or more (meth)acrylate monomers. The term “(meth)acryl . . . ,” as used herein, includes acryl . . . , methacryl . . . , and also includes diacryl . . . , dimethacryl . . . and polyacryl . . . and polymethacryl . . . or mixtures thereof. Thus, the term “(meth)acrylate monomer” includes acrylate and methacrylate monomers, diacrylate and dimethacrylate monomers, and other polyacrylate and polymethacrylate monomers. The polymer in the hydrophilic latex composition can include one or more (meth)acrylate monomers in an amount of 5% or greater by weight, based on the weight of the polymer in the hydrophilic latex composition. For example, the (meth)acrylate monomer can be in an amount of 7% or greater, 10% or greater, 20% or greater, 30% or greater, 40% or greater, 50% or greater, 60% or greater, 65% or greater, 70% or greater, 75% or greater, 80% or greater, 85% or greater, 90% or greater, 95% or greater, or up to 100% by weight, based on the weight of the polymer. In some embodiments, the one or more (meth)acrylate monomers can be in an amount of 100% or less, 95% or less, 90% or less, 85% or less, 80% or less, 75% or less, 70% or less, 65% or less, 60% or less, 55% or less, 50% or less, 45% or less, 40% or less, 35% or less, 30% or less, or 25% or less, by weight, based on the weight of the polymer in the hydrophilic latex composition. In some embodiments, the one or more (meth)acrylate monomers can be in an amount of from 5% to 100%, from 20% to 100%, from 40% to 95%, from 50% to 95%, from 65% to 95%, or from 65% to 85% by weight, based on the weight of the polymer in the hydrophilic latex composition.

Suitable (meth)acrylate monomers include esters of α,β-monoethylenically unsaturated mono- and dicarboxylic acids having 3 to 6 carbon atoms with alkanols having 1 to 12 carbon atoms (e.g. esters of acrylic acid, methacrylic acid, maleic acid, fumaric acid, or itaconic acid, with C1-C12, C1-C8, or C1-C4 alkanols such as ethyl, n-butyl, isobutyl and 2-ethylhexyl acrylates and methacrylates, dimethyl maleate and n-butyl maleate). Specific examples of suitable (meth)acrylate monomers for use in the polymer binder include methyl (meth)acrylate, ethyl (meth)acrylate, n-butyl (meth)acrylate, iso-butyl (meth)acrylate, tert-butyl (meth)acrylate, isobutyl (meth)acrylate, n-hexyl (meth)acrylate, 2-ethylhexyl (meth)acrylate, n-heptyl (meth)acrylate, 2-methylheptyl (meth)acrylate, octyl (meth)acrylate, isooctyl (meth)acrylate, n-nonyl (meth)acrylate, isononyl (meth)acrylate, ndecyl (meth)acrylate, isodecyl (meth)acrylate, dodecyl (meth)acrylate, heptadecyl (meth)acrylate, lauryl (meth)acrylate, tridecyl (meth)acrylate, stearyl (meth)acrylate, glycidyl (meth)acrylate, allyl (meth)acrylate, tetrahydrofurfuryl (meth)acrylate, cyclohexyl (meth)acrylate, 2-propylheptyl (meth)acrylate, behenyl (meth)acrylate, or combinations thereof. Other suitable (meth)acrylate monomers include alkyl crotonates, acetoacetoxyethyl (meth)acrylate, acetoacetoxypropyl (meth)acrylate, hydroxyethyl (meth)acrylate, 2-ethoxyethyl (meth)acrylate, 2-methoxy (meth)acrylate, 2-(2-ethoxyethoxy)ethyl (meth)acrylate, 2-phenoxyethyl (meth)acrylate, caprolactone (meth)acrylate, polypropyleneglycol mono(meth)acrylate, polyethyleneglycol (meth)acrylate, benzyl (meth)acrylate, 2,3-di(acetoacetoxy)propyl (meth)acrylate, hydroxypropyl (meth)acrylate, methylpolyglycol (meth)acrylate, 3,4-epoxycy clohexylmethyl (meth)acrylate, 1,6 hexanediol di(meth)acrylate, 1,4 butanediol di(meth)acrylate, or combinations thereof.

In certain embodiments, the polymer in the hydrophilic latex composition can be derived from (meth)acrylic acid monomers. Examples of suitable (meth)acrylic acid monomers include α,β-monoethylenically unsaturated mono- and dicarboxylic acids having 3 to 6 carbon atoms. Specific examples of suitable (meth)acrylic acid monomers include acrylic acid, methacrylic acid, maleic acid, fumaric acid, or itaconic acid, crotonic acid, dimethacrylic acid, ethylacrylic acid, allylacetic acid, vinylacetic acid, mesaconic acid, methylenemalonic acid, citraconic acid, or mixtures thereof. The polymer can be derived from 0%, 0.5% or greater, 1.0% or greater, 1.5% or greater, 2.5% or greater, 3.0% or greater, 3.5% or greater, 4.0% or greater, or 5.0% or greater, by weight of a (meth)acrylic acid monomer. In some embodiments, the polymer can be derived 25% or less, 20% or less, 15% or less, or 10% or less, by weight of a (meth)acrylic acid monomer. In some embodiments, the polymer can be derived from 0.5%-25%, from 0.5%-10%, from 1.0%-9%, from 2.0%-8% or from 0.5%-5%, by weight of a (meth)acrylic acid monomer.

As further described herein, the polymer in the hydrophilic latex composition can be derived from a vinyl aromatic monomer (e.g. styrene, α-methylstyrene, o-chlorostyrene, and vinyltoluenes). In some embodiments, the polymer can include styrene. The styrene can be in an amount of 5% or greater by weight, based on the weight of the polymer. For example, the styrene can be in an amount of 7% or greater, 10% or greater, 20% or greater, 30% or greater, 40% or greater, 50% or greater, 60% or greater, or 70% or greater by weight, based on the weight of the polymer. In some embodiments, the styrene can be in an amount of 75% or less, 70% or less, 65% or less, 60% or less, 55% or less, 50% or less, 45% or less, 40% or less, 35% or less, 30% or less, 25% or less, 20% or less, 15% or less, or 10% or less, by weight, based on the weight of the polymer. In some embodiments, styrene can be in an amount of from 0% to 85%, from greater than 0% to 90%, from 5% to 80%, from 5% to 70%, from 10% to 50%, or from 10% to 45% by weight, based on the weight of the polymer.

In some examples, the hydrophilic latex composition can include a (meth)acrylic based latex polymer, a styrene-(meth)acrylic based latex polymer, or blends thereof. When used, the (meth)acrylic based latex polymer can include 80% or greater, preferably from 80% to less than 100% by weight of (meth)acrylate monomers. In some cases, the (meth)acrylic based latex polymer is a straight acrylic latex polymer. When used, the styrene (meth)acrylic latex can include styrene, a (meth)acrylate monomer, and optionally, one or more additional monomers. In some embodiments, the weight ratio of the (meth)acrylate monomer to styrene can be 25:75 or greater, 30:70 or greater, 35:65 or greater, or 40:60 or greater. For example, the weight ratio of the (meth)acrylate monomer to styrene in the polymer can be from 5:95 to 95:5, from 20:80 to 95:5, from 20:80 to 80:20, from 30:70 to 95:5, from 30:70 to 70:30, or from 40:60 to 60:40. In some examples, the polymer can be a random copolymer, such as a random styrene-(meth)acrylate copolymer.

In certain embodiments, the polymer in the hydrophilic latex composition can be derived from one or more additional ethylenically-unsaturated monomers selected from anhydrides of α,β-monoethylenically unsaturated mono- and dicarboxylic acids (e.g. maleic anhydride, itaconic anhydride, and methylmalonic anhydride); acrylamides and alkyl-substituted acrylamides (e.g. (meth)acrylamide, N-tert-butylacrylamide, and N-methyl(meth)acrylamide); (meth)acrylonitrile; 1,2-butadiene (i.e. butadiene); vinyl and vinylidene halides (e.g. vinyl chloride and vinylidene chloride); vinyl esters of C₁-C₁₈ mono- or dicarboxylic acids (e.g. vinyl acetate, vinyl propionate, vinyl n-butyrate, vinyl laurate and vinyl stearate); C₁-C₄ hydroxyalkyl esters of C₃-C₆ mono- or dicarboxylic acids, especially of acrylic acid, methacrylic acid or maleic acid, or their derivatives alkoxylated with from 2 to 50 moles of ethylene oxide, propylene oxide, butylene oxide or mixtures thereof, or esters of these acids with C₁-C₁₈ alcohols alkoxylated with from 2 to 50 mole of ethylene oxide, propylene oxide, butylene oxide or mixtures thereof (e.g. hydroxyethyl (meth)acrylate, hydroxypropyl (meth)acrylate, and methylpolyglycol acrylate); monomers containing glycidyl groups (e.g. glycidyl methacrylate); linear 1-olefins, branched-chain 1-olefins or cyclic olefins (e.g., ethene, propene, butene, isobutene, pentene, cyclopentene, hexene, and cyclohexene); vinyl and allyl alkyl ethers having 1 to 40 carbon atoms in the alkyl radical, wherein the alkyl radical can possibly carry further substituents such as a hydroxyl group, an amino or dialkylamino group, or one or more alkoxylated groups (e.g., methyl vinyl ether, ethyl vinyl ether, propyl vinyl ether, isobutyl vinyl ether, 2-ethylhexyl vinyl ether, vinyl cyclohexyl ether, vinyl 4-hydroxybutyl ether, decyl vinyl ether, dodecyl vinyl ether, octadecyl vinyl ether, 2-(diethylamino)ethyl vinyl ether, 2-(di-N-butylamino)ethyl vinyl ether, methyldiglycol vinyl ether, and the corresponding allyl ethers); sulfo-functional monomers (e.g., allylsulfonic acid, methallylsulfonic acid, styrenesulfonate, vinylsulfonic acid, allyloxybenzenesulfonic acid, 2-acrylamido-2-methylpropanesulfonic acid, and their corresponding alkali metal or ammonium salts, sulfopropyl acrylate, and sulfopropyl methacrylate); vinylphosphonic acid, dimethyl vinylphosphonate, and other phosphorus monomers (e.g., phosphoethyl (meth)acrylate); alkylaminoalkyl (meth)acrylates or alkylaminoalkyl(meth)acrylamides or quaternization products thereof (e.g., 2-(N,N-dimethylamino)ethyl (meth)acrylate, 3-(N,N-dimethylamino)propyl (meth)acrylate, 2-(N,N,N-trimethylammonium)ethyl (meth)acrylate chloride, 2-dimethylaminoethyl(meth)acrylamide, 3-dimethylaminopropyl(meth)acrylamide, and 3-trimethylammoniumpropyl(meth)acrylamide chloride); allyl esters of C₁-C₃₀ monocarboxylic acids; N-vinyl compounds (e.g., N-vinylformamide, N-vinyl-N-methylformamide, N-vinylpyrrolidone, N-vinylimidazole, 1-vinyl-2-methylimidazole, 1-vinyl-2-methylimidazoline, N-vinylcaprolactam, vinylcarbazole, 2-vinylpyridine, and 4-vinylpyridine); monomers containing 1,3-diketo groups (e.g., acetoacetoxyethyl (meth)acrylate or diacetone acrylamide); monomers containing urea groups (e.g., ureidoethyl (meth)acrylate, acrylamidoglycolic acid, and methacrylamidoglycolate methyl ether); monoalkyl itaconates; monoalkyl maleates; hydrophobic branched ester monomers; monomers containing silyl groups (e.g., trimethoxysilylpropyl methacrylate), vinyl esters of branched mono-carboxylic acids having a total of 8 to 12 carbon atoms in the acid residue moiety and 10 to 14 total carbon atoms such as, vinyl 2-ethylhexanoate, vinyl neo-nonanoate, vinyl neo-decanoate, vinyl neo-undecanoate, vinyl neo-dodecanoate and mixtures thereof, and copolymerizable surfactant monomers (e.g., those sold under the trademark ADEKA REASOAP).

In some embodiments, the polymer can include the one or more additional monomers in an amount of greater than 0% to 20% by weight, based on the weight of the polymer in the hydrophilic latex composition. For example, the polymer can include the one or more additional monomers in an amount of 0.5% to 15%, 0.5% to 10%, 0.5% to 5%, 0.5% to 4%, 0.5% to 3%, 0.5% to 2%, or 0.5% to 1% by weight, based on the weight of the polymer in the hydrophilic latex composition.

The polymer in the hydrophilic latex composition can include one or more crosslinking monomers. Exemplary crosslinking monomers include N-alkylolamides of α,β-monoethylenically unsaturated carboxylic acids having 3 to 10 carbon atoms and esters thereof with alcohols having 1 to 4 carbon atoms (e.g., N-methylolacrylamide and N-methylolmethacrylamide); glycidyl (meth)acrylate; glyoxal based crosslinkers; monomers containing two vinyl radicals; monomers containing two vinylidene radicals; and monomers containing two alkenyl radicals. Other crosslinking monomers include, for instance, diesters of dihydric alcohols with α,β-monoethylenically unsaturated monocarboxylic acids, of which in turn acrylic acid and methacrylic acid can be employed. Examples of such monomers containing two non-conjugated ethylenically unsaturated double bonds can include alkylene glycol diacrylates and dimethacrylates, such as ethylene glycol diacrylate, 1,3-butylene glycol diacrylate, 1,4-butylene glycol diacrylate and propylene glycol diacrylate, divinylbenzene, vinyl methacrylate, vinyl acrylate, allyl methacrylate, allyl acrylate, diallyl maleate, diallyl fumarate, methylenebisacrylamide, and mixtures thereof. In some embodiments, the polymer can include from 0.01% to 5% by weight of the polymer, of the crosslinking agent.

The polymer in the hydrophilic latex composition can have a glass-transition temperature (T_{g}), as measured by differential scanning calorimetry (DSC) using the mid-point temperature as described, for example, in ASTM 3418/82, of from −90° C. to less than 50° C. In some embodiments, the polymer has a measured T_{g} of −90° C. or greater (for example, −80° C. or greater, −70° C. or greater, −60° C. or greater, −50° C. or greater, −40° C. or greater, −30° C. or greater, −20° C. or greater, −10° C. or greater, 0° C. or greater, 10° C. or greater, 20° C. or greater, or 25° C. or greater). In some cases, the polymer has a measured T_{g} of 40° C. or less (e.g., less than 40° C., 30° C. or less, 25° C. or less, 20° C. or less, 10° C. or less, 0° C. or less, −10° C. or less, −20° C. or less, −25° C. or less, −30° C. or less, −35° C. or less, −40° C. or less, −45° C. or less, or −50° C. or less). In certain embodiments, the polymer has a measured T_{g} of from −90° C. to 40° C., from −90° C. to 30° C., from −90° C. to 25° C., −90° C. to 0° C., −90° C. to −10° C., from −80° C. to 25° C., from −80° C. to 10° C., from −80° C. to 0° C., from −80° C. to −10° C., from −60° C. to 30° C., from −60° C. to 25° C., from −60° C. to 0° C., from −60° C. to less than 0° C. or from −40° C. to less than 0° C.

Joncryl® 3030 and Acronal Optive® 4655X are commercially available straight (meth)acrylic latex compositions from BASF. Joncryl® 3025, 3040, and 3050 are commercially available styrene-acrylic latex compositions from BASF.

Hydrophobic Treatments

As described herein, the mineral pigment can be surface treated with a hydrophobic material. To impart hydrophobicity to the mineral pigments, the hydrophobic material should have relatively low solubility in water. For instance, the mineral pigment can include a hydrophobic material having a water solubility of 1 g/100 g water or less at 20° C. For example, the hydrophobic material can have a water solubility in water, measured at 20° C., of 0.8 g/100 g water or less, 0.6 g/100 g water or less, 0.2 g/100 g water or less, 0.1 g/100 g water or less, 0.05 g/100 g water or less, 0.03 g/100 g water or less, or 0.01 g/100 g water or less.

In some cases, the hydrophobic material includes silicon-containing compounds. The silicon-containing compounds can be derived from an organosilane. The organosilane can be represented by the formula (R¹)—(Si)—(OR²)₃, wherein R¹ and R² are independently for each occurrence, selected from a C₁-C₁₀ alkyl group, a C₂-C₁₀ alkenyl group, a C₁-C₁₀ alkoxy group, a C₁-C₁₀ alkylthio group, or a C₁-C₁₀ alkylamino group. In some embodiments, R¹ is a C₁-C₈ substituted or unsubstituted alkyl, a C₂-C₈ substituted or unsubstituted alkenyl, a C₁-C₁₀ alkoxy group, or a C₁-C₁₀ alkylamino group. The R² groups can be the same or different. In some examples, the organosilane comprises a vinyl silane. In other examples, the organosilane comprises vinyltrimethoxysilane, vinyltriethoxysilane, vinyl tris(2-methoxyethoxysilane), vinyl triisopropoxysilane, (meth)acryloyloxypropyl trimethoxysilane, γ-(meth)acryloxypropyl trimethoxysilane, γ-(meth)acryloxypropyl triethoxysilane, (3-methacryloxypropyl)-trimethoxysilane, (3-methacryloxypropyl)-triethoxysilane, (3-methacryloxypropyl)-triisopropoxysilane, 2-methyl-2-propenoic acid 3-[tris-(1-methylethoxy)-silyl]-propyl ester, (3-methacryloxypropyl)-methyldiethoxysilane, 3-glycidoxypropyl methyldiethoxysilane, 3-glycidoxypropyl methyldimethoxysilane, or a mixture thereof. In some examples, the organosilane comprises vinyltrimethoxysilane, vinyltriethoxysilane, vinyl tris(2-methoxyethoxysilane), vinyl triisopropoxysilane, gamma-methacryloxypropyltrimethoxy silane, or combinations thereof other examples of organosilanes include alkoxysilanes such as methyl triethoxysilane, methyl trimethoxysilane, methyl triphenoxysilane, propyl triphenoxysilane, methyl tricyclopentoxysilane, propyl tricyclohexoxy silane, methyl tricyclooctoxysilane, propyl diethoxy phenoxysilane, methyl tripropoxysilane, methyl tri-n-amyloxysilane, propyl triisopropoxysilane, ethyl triethoxysilane, diethyl diethoxysilane, isopropyl triethoxysilane, n-butyl triethoxysilane, n-amyl triethoxysilane, n-amyl trimethoxysilane, phenyl triethoxysilane, cyclopentyl triethoxysilane, cyclohexyl triethoxysilane, cyclooctyl triethoxysilane, dimethyl diethoxysilane, methyl ethyl diethoxysilane, tri(n-propyl)ethoxysilane, n-propyl trimethoxysilane, n-propyl triethoxysilane, di(n-propyl)diethoxysilane, trimethyl ethoxysilane, diphenyl diethoxysilane, diethyl diethoxysilane, n-octyl triethoxysilane, methyl tri(methoxyethoxy)silane, propyl tri(ethoxyethoxy)silane, 1H,1H,2H,2H-perfluorooctyltriethoxysilane, trimethoxy(octadecyl)silane, triethoxy(octyl)silane, and trialkoxycaprylylsilanes (e.g., trimethoxycaprylylsilane). The organosilane can include chlorosilanes such as octadecyltrichlorosilane (OTS), octadecyltrichlorosilane (OTS), hexyltrichlorosilane (HTS), and ethyltrichlorosilane (ETS). In some examples, the organosilane can comprise vinyltriethoxysilane. In other examples, the organosilane consists of vinylethoxysilane.

The hydrophobic material can, for example, be derived from greater than 0% such as 0.5% or more by weight of the organosilane (e.g., 1% or more, 5% or more, 10% or more, 15% or more, 20% or more, 25% or more, 30% or more, 35% or more, 40% or more, 45% or more, 50% or more, 60% or more, 70% or more, 75% or more, 80% or more, 85% or more, 90% or more, 95% or more, 98% or more, 99% or more, or up to 100% by weight), based on the total weight or the hydrophobic material. In some examples, the hydrophobic material can be derived from 100% or less by weight of the organosilane (e.g., 95% or less, 90% or less, 85% or less, 80% or less, 75% or less, 70% or less, 65% or less, 55% or less, 50% or less, 45% or less, 40% or less, 35% or less, 30% or less, 25% or less, 20% or less, or 15% or less), based on the total weight or the hydrophobic material. The amount of organosilane the hydrophobic material is derived from can range from any of the minimum values described above to any of the maximum values described above. For example, the hydrophobic material can be derived from greater than 0% to 100% by weight of the organosilane such as from 10% to 99% by weight of the organosilane (e.g., from 10% to 95%, from 25% to 95%, or from 50% to 90%), based on the total weight or the hydrophobic material.

In some embodiments, the hydrophobic material can include an aminosilane. The aminosilane can be represented by the formula H₂N—R¹—Si(R²)₃, wherein R¹ and R² are independently, for each occurrence, selected from a C₁-C₁₀ alkyl group, a C₂-C₁₀ alkenyl group, a C₁-C₁₀ alkoxy group, a C₁-C₁₀ alkylthio group, and a C₁-C₁₀ alkylamino group. Exemplary aminosilanes can include 3-aminopropylmethyldiethoxysilane, 3-aminopropyltrimethoxysilane, 3-aminopropyltriethoxysilane, N-(2-aminoethyl-3-aminopropyl)-trimethoxysilane or combinations thereof. The hydrophobic material can include from greater than 0% to 90% by weight of the one or more aminosilanes (e.g., from 5% to 50%, from 5% to 25%, or from 5% to 10%).

In some embodiments, the hydrophobic material can include a multivinyl siloxane oligomer. Multivinyl siloxane oligomers are described in U.S. Pat. No. 8,906,997, which is hereby incorporated by reference in its entirety. The multivinyl siloxane oligomer can include oligomers having a Si—O—Si backbone. For example, the multivinyl siloxane oligomer can have a structure represented by the formula

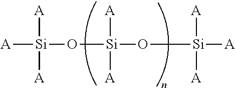

wherein each of the A groups are independently selected from hydrogen, hydroxy, alkoxy, substituted or unsubstituted C₁₋₄ alkyl, or substituted or unsubstituted C₂₋₄ alkenyl and n is an integer from 1 to 50 (e.g., from 2 to 50, from 2 to 25, from 4 to 50, from 4 to 25, from 5 to 25, or 10). As used herein, the terms “alkyl” and “alkenyl” include straight- and branched-chain monovalent substituents. Examples include methyl, ethyl, propyl, butyl, isobutyl, vinyl, allyl, and the like. The term “alkoxy” includes alkyl groups attached to the molecule through an oxygen atom. Examples include methoxy, ethoxy, and isopropoxy.

In some embodiments, at least one of the A groups in the repeating portion of multivinyl siloxane are vinyl groups. The presence of multiple vinyl groups in the multivinyl siloxane oligomers enables the oligomer molecules to act as crosslinkers in compositions comprising the copolymers. In some examples, the multivinyl siloxane oligomer can have the following structure represented by the formula:

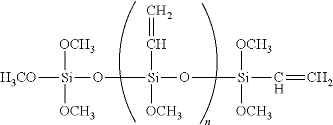

wherein n is an integer from 1 to 50 (e.g., from 2 to 50, from 2 to 25, from 4 to 50, from 4 to 25, from 5 to 25, or 10). Further examples of suitable multivinyl siloxane oligomers include DYNASYLAN 6490, a multivinyl siloxane oligomer derived from vinyltrimethoxysilane, and DYNASYLAN 6498, a multivinyl siloxane oligomer derived from vinyltriethoxysilane, both commercially available from Evonik Degussa GmbH (Essen, Germany). Other suitable multivinyl siloxane oligomers include VMM-010, a vinylmethoxysiloxane homopolymer, and VEE-005, a vinylethoxysiloxane homopolymer, both commercially available from Gelest, Inc. (Morrisville, Pa.).

The hydrophobic material can include a fatty acid, a fatty acid salt, or a combination thereof. Fatty acids and their salts usually have non-polar alkyl chains and polar carboxylic functional groups. Suitable fatty acids or fatty acid salts for use as the hydrophobic material can be derived from a C₆-or greater fatty acid. For example, the fatty acids or fatty acid salts can be derived from a C₇- or greater, a C₈- or greater, a C₉- or greater, a C₁₀- or greater, a C₁₂- or greater, or a C₁₄- or greater fatty acid. In some embodiments, the fatty acids or fatty acid salts can be derived from a C₂₆- or less, a C₂₄- or less, a C₂₀- or less, or a C₁₈- or less fatty acid. In some embodiments, the fatty acid salts can be derived from a C₆-C₂₆, a C₆-C₂₄, a C₈-C₂₄, a C₁₀-C₂₄, a C₁₂-C₂₄, a C₆-C₂₀, a C₈-C₂₀, a C₁₀-C₂₀, or a C₁₂-C₂₀ fatty acid. The fatty acids or fatty acid salts used in the composites can include saturated and/or unsaturated fatty acids as well as branched and/or unbranched carbon chain. In some embodiments, the “fatty acid” may additionally include hydroxyl groups or epoxy groups. In some embodiments, at least 50% by weight of the fatty acids or fatty acid salts can be saturated.

In some embodiments, at least 50% by weight of the fatty acids or fatty acid salts comprise a C₁₂- or greater hydrocarbon chain. For example, at least 55% by weight (e.g., at least 60%, at least 65%, at least 70%, at least 75%, at least 80%, at least 85%, at 90%, at least 95%, from 50% to 99%, from 55% to 99%, from 60% to 98%, from 70% to 98%, from 80% to 98%, from 80% to 95%, or from 85% to 95%) of the fatty acids or fatty acid salts comprise a C₁₂- or greater hydrocarbon chain.

Specific examples of fatty acids or fatty acid salts can include salts derived from lauric acid, maleic acid, myristic acid, palmitic acid, stearic acid, palmitoleic acid, oleic acid, erucic acid, linoleic acid, linolenic acid, eleostearic acid, arachidonic acid, enanthic acid, caprylic acid, pelargonic acid, capric acid, pentadecylic acid, hepatadecanoic acid, behenic acid, lignoceric acid, myristoleic acid, trans-9-octadecenoic acid, vaccenic acid, stearidonic acid, gadoleic acid, eicosapentaenoic acid (EPA), cis-13-docosenoic acid, clupanodonic acid, docosahexaenoic acid (DHA), cis-15-tetracosenoic acid, or mixtures thereof.

The fatty acid salts can include any suitable cationic group. For example, the fatty acid salts can include a cationic group derived from a Group I metal, a Group II metal, a Group III metal, zinc, or ammonium. For example, the fatty acid salts can include sodium, potassium, calcium, magnesium, aluminum, or a mixture thereof. In some examples of the hydrophobic materials, the fatty acid salt can comprise calcium stearate. Calson 50 and 65 are commercially available calcium stearates from BASF.

The hydrophobic material can include an oil, wax, grease, a polyalkylene (e.g., polyethylene or polypropylene), a polychlorofluoro alkylene, an ester, glycerol, a paraffin based oil, estersil, a silicone, stearyl stearate, resins (e.g., polypropylene, polystyrene, polymethyl methacrylate, and polyphenylene oxide), polyvinyl alcohol, or a combination thereof. Suitable waxes known to those skilled in the art can include paraffin wax, animal waxes, mineral waxes, petroleum derivative waxes, and synthetic waxes. Joncryl Wax is a commercially available polyethylene-paraffin wax emulsion from BASF.

The hydrophobic material can include a styrene-butadiene latex. The styrene-butadiene latex can be selected from a styrene-butadiene copolymer (i.e., a polymer derived from butadiene and styrene monomers), a carboxylated styrene-butadiene copolymer (i.e., a polymer derived from butadiene, styrene, and carboxylic acid monomers), a styrene-butadiene-styrene block copolymer, a styrene-butadiene-acrylic copolymer (i.e., a polymer derived from butadiene, styrene, and one or more (meth)acrylate and/or (meth)acrylic acid monomers), or a combination thereof. In some embodiments, the weight ratio of styrene to butadiene monomers in the styrene-butadiene latex can be from 5:95 to 95:5, from 10:99 to 99:10, from 5:95 to 80:20, from 20:80 to 80:20, from 5:95 to 70:30, from 30:70 to 70:30, or from 40:60 to 60:40. For example, the weight ratio of styrene to butadiene can be 25:75 or greater, 30:70 or greater, 35:65 or greater, or 40:60 or greater. The styrene-butadiene latex can have a glass-transition temperature (T_{g}), as measured by differential scanning calorimetry (DSC) using the mid-point temperature as described, for example, in ASTM 3418/82, of from −90° C. to less than 50° C., such as from −90° C. to 40° C., from −90° C. to 30° C., from −90° C. to 25° C., −90° C. to 0° C., −90° C. to −10° C., from −80° C. to 25° C., from −80° C. to 10° C., from −80° C. to 0° C., from −80° C. to −10° C., from −60° C. to 25° C., from −60° C. to 0° C., or from −60° C. to less than 0°. Styronal 4606 is a commercially available styrene-butadiene latex binder from BASF.

As described herein, the mineral pigment is surface treated with a hydrophilic latex composition and a hydrophobic material. The surface treated pigment can include a combination of the hydrophilic latex composition and the hydrophobic material in an amount of greater than 0% by weight (e.g., 0.05% or more, 0.1% or more, 0.15% or more, 0.2% or more, 0.25% or more, 0.3% or more, 0.4% or more, 0.5% or more, 0.6% or more, 0.7% or more, 0.75% or more, 0.8% or more, 0.9% or more, 1.0% or more, 1.1% or more, 1.2% or more, 1.3% or more, 1.4% or more, 1.5% or more, 1.6% or more, 1.7% or more, 1.8% or more, 1.9% or more, 2.0% or more, 2.2% or more, 2.4% or more, 2.5% or more, 2.8% or more, 3.0% or more, 3.2% or more, 3.4% or more, 3.5% or more, 3.8% or more, 4.0% or more, 4.2% or more, 4.4% or more, 4.5% or more, 4.8% or more, 5.0% or more, 5.2% or more, 5.4% or more, 5.5% or more, 5.8% or more, 6.0% or more, 7.0% or more, 8.0% or more, 9.0% or more, or up to 10.0% by weight), based on the total weight of the surface treated pigment. The surface treated pigment can include the hydrophilic latex composition and the hydrophobic material in an amount of 10.0% or less by weight (e.g., 9.0% or less, 8.0% or less, 7.0% or less, 6.0% or less, 5.5% or less, 5.0% or less, 4.8% or less, 4.5% or less, 4.2% or less, 4.0% or less, 3.8% or less, 3.5% or less, 3.2% or less, 3.0% or less, 2.8% or less, 2.5% or less, 2.2% or less, 2.0% or less, 1.8% or less, 1.5% or less, 1.2% or less, 1.0% or less, or 0.5% or less), based on the total weight of the surface treated pigment. The amount of hydrophilic latex composition and the hydrophobic material present in the surface treated pigment can range from any of the minimum values described above to any of the maximum values described above. For example, the surface treated pigment can be derived from greater than 0% to 10.0% by weight of the hydrophilic latex composition and the hydrophobic material such as from 0.25% to 10.0% by weight (e.g., from greater than 0% to 8.0%, from greater than 0% to 7.0%, from greater than 0% to 6.0%, from 0.5% to 5.0%, from 0.5% to 4.0%, or from 0.5% to 3.0%), based on the total weight of the surface treated pigment.

The surface treated pigment can include the hydrophilic latex composition in an amount of greater than 0% by weight (e.g., 0.05% or more, 0.1% or more, 0.15% or more, 0.2% or more, 0.25% or more, 0.3% or more, 0.4% or more, 0.5% or more, 0.6% or more, 0.7% or more, 0.75% or more, 0.8% or more, 0.9% or more, 1.0% or more, 1.1% or more, 1.2% or more, 1.3% or more, 1.4% or more, 1.5% or more, 1.6% or more, 1.7% or more, 1.8% or more, 1.9% or more, 2.0% or more, 2.2% or more, 2.4% or more, 2.5% or more, 2.8% or more, 3.0% or more, 3.2% or more, 3.4% or more, 3.5% or more, 3.8% or more, 4.0% or more, 4.2% or more, 4.4% or more, 4.5% or more, 4.8% or more, 5.0% or more, 5.2% or more, 5.4% or more, 5.5% or more, 5.8% or more, or 6.0% or more by weight), based on the total weight of the surface treated pigment. The surface treated pigment can include the hydrophilic latex composition in an amount of 6.0% or less by weight (e.g., 5.5% or less, 5.0% or less, 4.8% or less, 4.5% or less, 4.2% or less, 4.0% or less, 3.8% or less, 3.5% or less, 3.2% or less, 3.0% or less, 2.8% or less, 2.5% or less, 2.2% or less, 2.0% or less, 1.8% or less, 1.5% or less, 1.2% or less, 1.0% or less, or 0.5% or less), based on the total weight of the surface treated pigment. The amount of hydrophilic latex composition present in the surface treated pigment can range from any of the minimum values described above to any of the maximum values described above. For example, the surface treated pigment can be derived from 0.25% to 6.0% by weight of the hydrophilic latex composition (e.g., from 0.5% to 5.0%, from 0.5% to 4.0%, or from 0.5% to 3.0%), based on the total weight of the surface treated pigment.

The surface treated pigment can include the hydrophobic material in an amount of greater than 0% by weight (e.g., 0.05% or more, 0.1% or more, 0.15% or more, 0.2% or more, 0.25% or more, 0.3% or more, 0.4% or more, 0.5% or more, 0.6% or more, 0.7% or more, 0.75% or more, 0.8% or more, 0.9% or more, 1.0% or more, 1.1% or more, 1.2% or more, 1.3% or more, 1.4% or more, 1.5% or more, 1.6% or more, 1.7% or more, 1.8% or more, 1.9% or more, 2.0% or more, 2.2% or more, 2.4% or more, 2.5% or more, 2.8% or more, 3.0% or more, 3.2% or more, 3.4% or more, 3.5% or more, 3.8% or more, 4.0% or more, 4.2% or more, 4.4% or more, 4.5% or more, 4.8% or more, 5.0% or more, 5.2% or more, 5.4% or more, 5.5% or more, 5.8% or more, or 6.0% or more by weight), based on the total weight of the surface treated pigment. The surface treated pigment can include the hydrophobic material in an amount of 6.0% or less by weight (e.g., 5.5% or less, 5.0% or less, 4.8% or less, 4.5% or less, 4.2% or less, 4.0% or less, 3.8% or less, 3.5% or less, 3.2% or less, 3.0% or less, 2.8% or less, 2.5% or less, 2.2% or less, 2.0% or less, 1.8% or less, 1.5% or less, 1.2% or less, 1.0% or less, or 0.5% or less), based on the total weight of the surface treated pigment. The amount of hydrophobic material present in the surface treated pigment can range from any of the minimum values described above to any of the maximum values described above. For example, the surface treated pigment can be derived from 0.25% to 6.0% by weight of the hydrophobic material (e.g., from 0.5% to 5.0%, from 0.5% to 4.0%, or from 0.5% to 3.0%), based on the total weight of the surface treated pigment.

In some embodiments, the weight ratio of hydrophilic latex composition and the hydrophobic material in the surface treated pigment can be from 1:4 to 4:1, from 1:4 to 3:1, from 1:4 to 2:1, from 1:4 to 1:1, from 1:4 to 1:2, from 1:3 to 3:1, from 1:3 to 2:1, from 1:3 to 1:1, from 1:3 to 1:2, or from 1:2 to 2:1.

Mineral Pigments

As described herein, the surface treated pigments include at least one mineral pigment surface treated with a hydrophilic latex composition and a hydrophobic material. The mineral pigment can be selected from clay, bentonite, mica, talc, attapulgite, silica, calcium carbonate, halloysite, wollastonite, nepheline syenite, feldspar, diatomaceous earth, zeolite, or a mixture thereof. In some examples, the mineral pigment can include clay. The clay can be a kandite clay such as kaolinite, anauxite, dickite, nacrite, halloysite, or a mixture thereof. In specific examples, the mineral pigment includes kaolin.

The mineral pigment can have any suitable particle size, depending on the specific coating it is being used in. In some embodiments, the mineral pigment can have an average particle size of 10.0 μm or less, 9.0 μm or less, 8.0 μm or less, 7.0 μm or less, 6.5 μm or less, 6.0 μm or less, 5.5 μm or less, 5.0 μm or less, 4.5 μm or less, 4.0 μm or less, 3.5 μm or less, 3.0 μm or less, 2.5 μm or less, 2.0 μm or less, 1.5 μm or less, 1.0 μm or less, or 0.5 μm or less, as determined by a Sedigraph 5100 Particle Size Analyzer. In some embodiments, the mineral pigment can have an average particle size of 0.1 μm or greater, 0.5 μm or greater, 1.0 μm or greater, 1.5 μm or greater, 2.0 μm or greater, 2.5 μm or greater, 3.0 μm or greater, 3.5 μm or greater, 4.0 μm or greater, 4.5 μm or greater, 5.0 μm or greater, 5.5 μm or greater, or 6.0 μm or greater, as determined by a Sedigraph 5100 Particle Size Analyzer. In some embodiments, the mineral pigment can have an average particle size of from 0.1 to 10.0 μm, from 0.1 to less than 7.0 μm, from 0.1 to 6.0 μm, from 0.5 to less than 7.0 μm, from 1.0 to less than 7.0 μm, from 2.0 to less than 7.0 μm, from 1.0 to 6.0 μm, from 0.1 to 2.5 μm, or from 0.1 to 2.0 μm, as determined by a Sedigraph 5100 Particle Size Analyzer.

The mineral pigments can be heat treated prior to, during, or after surface treatment. For example, the mineral pigments can be heat treated by any conventional method in the art such as spray drying, flash drying, rotary drying, or other conglomeration techniques. In other embodiments, when the mineral pigment is heated, it undergoes a series of characteristic changes, detectable by various methods including differential thermal analysis (DTA). Heat treatment can be employed to form one or more of partially calcined or fully calcined mineral pigment, depending on the temperature/duration of the heat treatment. In some embodiments, when the mineral pigment is kaolin, the heat treatment employed results in fully calcined kaolin. As used herein, “fully calcined kaolin” refers to kaolin that has been heat treated at a temperature from 900° C. to about 1200° C. In further embodiments, the heat treatment employed may result in metakaolin.

Properties of the Surface Treated Pigment

The surface treated pigment has a surface energy that is less than the surface energy of the untreated mineral pigment. Without wishing to be bound by theory, a particularly low surface energy is preferred when stain resistive properties is required. This is the case in particular with oily stains and dirt. Preferably, the surface treated pigment has a surface energy, wherein the surface treated pigment is not wetted by water and can also be readily cleaned to remove oily stain or dirt.

In some embodiments, surface treatment of the mineral pigments causes a decrease in the surface energy of the untreated mineral pigment. For example, the difference between the surface energy of the surface treated pigment and the surface energy of the untreated mineral pigment can be 1.0 mN/m or greater (e.g., 1.1 mN/m or greater, 1.2 mN/m or greater, 1.3 mN/m or greater, 1.4 mN/m or greater, 1.5 mN/m or greater, 1.6 mN/m or greater, 1.7 mN/m or greater, 1.8 mN/m or greater, 1.9 mN/m or greater, 2.0 mN/m or greater, 2.2 mN/m or greater, 2.4 mN/m or greater, 2.5 mN/m or greater, 2.7 mN/m or greater, 2.9 mN/m or greater, 3.0 mN/m or greater, 3.2 mN/m or greater, 3.5 mN/m or greater, 3.7 mN/m or greater, 4.0 mN/m or greater, 4.2 mN/m or greater, 4.5 mN/m or greater, or up to 5.0 mN/m). In some embodiments, the difference between the surface energy of the surface treated pigment and the surface energy of the untreated mineral pigment can be from 1.0 mN/m to 5.0 mN/m (e.g., from 1.0 mN/m to 5.0 mN/m, from 1.0 mN/m to 4.0 mN/m, from 1.0 mN/m to 3.0 mN/m, from 1.2 mN/m to 4.0 mN/m, or from 1.5 mN/m to 4.0 mN/m).

In some embodiments, the surface energy of the surface treated pigment is less than the surface energy of the mineral pigment treated with the hydrophilic latex composition alone. For example, the difference between the surface energy of the surface treated pigment and the surface energy of the mineral pigment treated with the hydrophilic latex composition can be 0.2 mN/m or greater (e.g., 0.3 mN/m or greater, 0.4 mN/m or greater, 0.5 mN/m or greater, 0.6 mN/m or greater, 0.7 mN/m or greater, 0.8 mN/m or greater, 0.9 mN/m or greater, 1.0 mN/m or greater, 1.2 mN/m or greater, 1.4 mN/m or greater, 1.5 mN/m or greater, 1.7 mN/m or greater, 1.9 mN/m or greater, or 2.0 mN/m or greater). In some embodiments, the difference between the surface energy of the surface treated pigment and the surface energy of the mineral pigment treated with the hydrophilic latex composition can be from 0.2 mN/m to 2.0 mN/m (e.g., from 0.2 mN/m to 1.8 mN/m, from 0.2 mN/m to 1.5 mN/m, from 0.4 mN/m to 2.0 mN/m, from 0.5 mN/m to 2.0 mN/m, or from 0.5 mN/m to 1.5 mN/m).

In some embodiments, the surface energy of the surface treated pigment is less than the surface energy of a mineral pigment treated with the hydrophobic material alone. For example, the difference between the surface energy of the surface treated pigment and the surface energy of the mineral pigment treated with the hydrophobic material can be 0.2 mN/m or greater (e.g., 0.3 mN/m or greater, 0.4 mN/m or greater, 0.5 mN/m or greater, 0.6 mN/m or greater, 0.7 mN/m or greater, 0.8 mN/m or greater, 0.9 mN/m or greater, 1.0 mN/m or greater, 1.2 mN/m or greater, 1.4 mN/m or greater, 1.5 mN/m or greater, 1.7 mN/m or greater, 1.9 mN/m or greater, or 2.0 mN/m or greater). In some embodiments, the difference between the surface energy of the surface treated pigment and the surface energy of the mineral pigment treated with the hydrophobic material can be from 0.2 mN/m to 2.0 mN/m (e.g., from 0.2 mN/m to 1.8 mN/m, from 0.2 mN/m to 1.5 mN/m, from 0.4 mN/m to 2.0 mN/m, from 0.5 mN/m to 2.0 mN/m, or from 0.5 mN/m to 1.5 mN/m).

Overall, the surface treated pigment can have a surface energy of less than 20 mN/m (e.g., less than 19 mN/m, less than 18 mN/m, less than 17 mN/m, less than 16 mN/m, less than 15 mN/m, less than 14 mN/m, less than 13 mN/m, less than 12 mN/m, less than 11 mN/m, less than 10 mN/m, less than 9 mN/m, less than 8 mN/m, less than 7 mN/m, less than 6 mN/m, or less than 5 mN/m). In some embodiments, the surface treated pigment can have a surface energy from 10 to 18 mN/m or from 12 to 16 mN/m.

The contact angle of the surface treated pigments is a surface property which reflects the pigment properties. In some instances, the surface treated pigments can exhibit large contact angle with water and from which stain or dirt, in particular oily stain and dirt, can be removed, for example, by washing off with water, or which promote the running off of water. The surface treated pigments generally have larger contact angles than the untreated mineral pigments.

In some embodiments, the surface of the surface treated pigment exhibits a water contact angle of at least 90° (e.g., at least 92°, at least 94°, at least 96°, at least 98°, at least 100°, at least 102°, at least 104°, at least 106°, at least 108°, at least 109°, at least 110°, at least 111°, at least 112°, at least 113°, at least 114°, at least 115°, at least 116°, at least 117°, at least 118°, at least 119°, or at least)120°, a dodecane contact angle of at least 50° (e.g., at least 51°, at least 52°, at least 53°, at least 54°,at least 55°, at least 56°, at least 57°, at least 58°, at least 59°, or at least 60°), or both a water contact angle of at least 90° (e.g., at least 92°, at least 94°, at least 96°, at least 98°, at least 100°, at least 102°, at least 104°, at least 106°, at least 108°, at least 109°, at least 110°, at least 111°, at least 112°, at least 113°, at least 114°, at least 115°, at least 116°, at least 117°, at least 118°, at least 119°, or at least 120°) and a dodecane contact angle of at least 50° (e.g., at least 51°, at least 52°, at least 53°, at least 54°, at least 55°, at least 56°, at least 57°, at least 58°, at least 59°, or at least 60°). The surface of the surface treated pigment exhibits can exhibit a water contact angle of less than 150° (e.g., 130° or less, 125° or less, 120° or less, 119° or less, 118° or less, 117° or less, 116° or less, or 115° or less), or a dodecane contact angle of less than 90° or less (e.g., 85° or less, 80° or less, 75° or less, 70° or less, 65° or less, 60° or less, 59° or less, or 58° or less).

As described herein, the water contact angle and the dodecane contact angle of the surface treated pigment is generally higher than the water contact angle and the dodecane contact angle of the untreated mineral pigment. In some embodiments, both the water contact angle and the dodecane contact angle of the surface treated pigment are higher than the water contact angle and the dodecane contact angle of a mineral pigment treated with the hydrophobic material alone. In further embodiments, the water contact angle of the surface treated pigment can be less than the water contact angle of the mineral pigment treated with the hydrophilic latex composition alone. In even further embodiments, the dodecane contact angle of the surface treated pigment can be greater than the dodecane contact angle of the mineral pigment treated with the hydrophilic latex composition alone.

The surface treated pigment is preferably less wettable by water, compared to the untreated mineral pigment or mineral pigment treated with the hydrophilic latex composition alone, as determined by ASTM 7315-17. In general, the turbidity of a mixture comprising water and the surface treated pigment increases with increased wettability of the surface treated pigment. In some embodiments, a mixture of the surface treated pigment in contact with water for a period of at least 120 minutes, can exhibit a turbidity of 1.5 NTU or less, 1.4 NTU or less, 1.3 NTU or less, 1.2 NTU or less, 1.1 NTU or less, 1.0 NTU or less, 0.9 NTU or less, 0.8 NTU or less, 0.7 NTU or less, 0.6 NTU or less, 0.5 NTU or less, 0.4 NTU or less, from 0.4 to 1.5 NTU, from 0.4 to 1.1 NTU, or from 0.5 to 1.2 NTU.

Coating Compositions

Provided herein are coating compositions comprising a polymer binder system and a surface treated pigment (mineral pigment surface treated with a hydrophilic latex composition and a hydrophobic material) as described herein. The coating compositions when dried, can form a film which exhibits stain and/or dirt resistance properties, as determined by ASTM D 4828-94. In some examples, the coating compositions comprise the surface treated pigment and a polymer binder system selected from acrylic homopolymers, styrene-acrylic-based copolymers, styrene-butadiene-based copolymers, styrene-butadiene-styrene copolymers, vinyl acrylic copolymers, ethylene vinyl acetate copolymers, polychloroprene, alkyd resin, polyester resins, polyurethane resins, silicone resins, petroleum resins, epoxy resins, blends thereof, or copolymers thereof.

The coating compositions can include the surface treated pigment in an amount from greater than 0% by weight to 90% by weight (e.g., 0.1% or greater, 0.5% or greater, 1% or greater, 2.5% or greater, 5% or greater, 7% or greater, 10% or greater, 12.5% or greater, 15% or greater, 18% or greater, 20% or greater, 22% or greater, 25% or greater, 28% or greater, 30% or greater, 35% or greater, 40% or greater, 45% or greater, 50% or greater, 55% or greater, 60% or greater, 65% or greater, 70% or greater, 75% or greater, 80% or greater, 85% or greater, or up to 90%by weight), based on the total dry weight of the coating composition. The coating composition can include the surface treated pigment in an amount of 90% by weight or less, 85% by weight or less, 80% by weight or less, 75% by weight or less, 70% by weight or less, 65% by weight or less, 60% by weight or less, 55% by weight or less, 50% by weight or less, 45% by weight or less, 40% by weight or less, 35% by weight or less, 30% by weight or less, 28% by weight or less, 27% by weight or less, 26% by weight or less, 25% by weight or less, 22% by weight or less, 20% by weight or less, 15% by weight or less, 10% by weight or less, 8% by weight or less, 7% by weight or less, 6% by weight or 5% by weight or less, 4% by weight or less, 3% by weight or less, 2% by weight or less, or 1% by weight or less), based on the total dry weight of the coating composition. The coating composition can include the surface treated pigment in an amount from 0.1% by weight to 99.9% by weight, from 0.5% by weight to 90% by weight, from 0.5% by weight to 85% by weight, from 1% by weight to 90% by weight, from 5% by weight to 85% by weight, from 10% by weight to 90% by weight, from 15% by weight to 85% by weight, based on the total dry weight of the coating composition.

The coating composition can include the polymer binder system in an amount from greater than 0% by weight to 99.9% by weight (e.g., 0.1% or greater, 0.5% or greater, 1% or greater, 2.5% or greater, 5% or greater, 7% or greater, 10% or greater, 12.5% or greater, 15% or greater, 20% or greater, 22% or greater, 25% or greater, 30% or greater, 35% or greater, 40% or greater, 45% or greater, 50% or greater, 55% or greater, 60% or greater, 65% or greater, 70% or greater, 75% or greater, 80% or greater, 85% or greater, 90% or greater, 95% or greater, or up to 99.9% by weight), based on the total dry weight of the coating composition. The coating composition can include the polymer binder system in an amount of 99.9% by weight or less, 99% by weight or less, 98% by weight or less, 95% by weight or less, 90% by weight or less, 85% by weight or less, 80% by weight or less, 75% by weight or less, 70% by weight or less, 65% by weight or less, 60% by weight or less, 55% by weight or less, 50% by weight or less, 45% by weight or less, 40% by weight or less, 35% by weight or less, 30% by weight or less, 25% by weight or less, 20% by weight or less, 15% by weight or less, 10% by weight or less, 8% by weight or less, 7% by weight or less, 6% by weight or 5% by weight or less, 4% by weight or less, 3% by weight or less, 2% by weight or less, or 1% by weight or less), based on the total dry weight of the coating composition. The coating composition can include the polymer binder system in an amount from 0.1% by weight to 99.9% by weight, from 0.5% by weight to 99% by weight, from 0.5% by weight to 95% by weight, from 1% by weight to 90% by weight, from 5% by weight to 99.9% by weight, from 10% by weight to 90% by weight, from 15% by weight to 85% by weight, based on the total dry weight of the coating composition.

The coating compositions can include additional components. For example, the coating compositions can include an additive such as a pigment dispersant, an inorganic or organic filler, an additional pigment, a pigment extender, a thickener, a defoamer, a surfactant, a biocide, an adhesion enhancer, a coalescing agent, a film forming aid, a flame retardant, a stabilizer, a curing agent, a flow agent, a leveling agent, a light stabilizer, a wetting agent, a hardener, a tackifier, an anti-settling aid, a texture-improving agent, an antiflocculating agent, or a combination thereof. The additive can be added to impart certain properties to the coating compositions such as thickness, texture, handling, fluidity, smoothness, whiteness, increased density or weight, decreased porosity, increased opacity, flatness, glossiness, decreased blocking resistance, barrier properties, and the like.

In some embodiments, the coating compositions include an untreated mineral filler and/or an additional pigment. When present, the untreated mineral filler and/or pigment can be selected from TiO₂ (in both anatase and rutile forms), clay (aluminum silicate), CaCO₃ (in both ground and precipitated forms), aluminum trihydrate, fly ash, or aluminum oxide, silicon dioxide, magnesium oxide, talc (magnesium silicate), barytes (barium sulfate), zinc oxide, zinc sulfite, sodium oxide, potassium oxide, and mixtures thereof. Examples of commercially available titanium dioxide pigments are KRONOS® 2101, KRONOS® 2310, available from Kronos WorldWide, Inc., TI-PURE® R-900, available from DuPont, or TIONA® AT1 commercially available from Millennium Inorganic Chemicals. Titanium dioxide is also available in concentrated dispersion form. An example of a titanium dioxide dispersion is KRONOS® 4311, also available from Kronos Worldwide, Inc. Suitable pigment blends of mineral fillers are sold under the marks MINEX® (oxides of silicon, aluminum, sodium and potassium commercially available from Unimin Specialty Minerals), CELITE® (aluminum oxide and silicon dioxide commercially available from Celite Company), and ATOMITE® (commercially available from Imerys Performance Minerals). Exemplary fillers also include clays such as attapulgite clays and kaolin clays including those sold under the ATTAGEL® and ANSILEX® marks (commercially available from BASF Corporation). Additional fillers include nepheline syenite, (25% nepheline, 55% sodium feldspar, and 20% potassium feldspar), feldspar (an aluminosilicate), diatomaceous earth, calcined diatomaceous earth, talc (hydrated magnesium silicate), aluminosilicates, silica (silicon dioxide), alumina (aluminum oxide), mica (hydrous aluminum potassium silicate), pyrophyllite (aluminum silicate hydroxide), perlite, baryte (barium sulfate), wollastonite (calcium metasilicate), and combinations thereof. More preferably, the coating compositions can include TiO₂, CaCO₃, and/or a clay. In some embodiments, the coating composition does not include a pigment and/or a mineral filler other than the surface treated pigment described herein.

When present, the untreated mineral filler and/or pigment can comprise particles having a number average particle size of 50 microns or less (e.g., 45 microns or less, 40 microns or less, 35 microns or less, 30 microns or less, 25 microns or less, 20 microns or less, 18 microns or less, 15 microns or less, 10 microns or less, 8 microns or less, or 5 microns or less). In some embodiments, the untreated mineral filler and/or pigment can have a number average particle size of 10 microns or greater, 12 microns or greater, 15 microns or greater, 20 microns or greater, 25 microns or greater, 30 microns or greater, 35 microns or greater, 40 microns or greater, or 45 microns or greater. In some embodiments, the untreated mineral filler and/or pigment can have a number average particle size of from 10 microns to 50 microns, from 10 microns to 35 microns, or from 10 microns to 25 microns.

The untreated mineral filler and/or pigment, if present, can be present in an amount of 1% by weight or greater, based on the total weight of the coating composition. For example, the untreated mineral filler and/or pigment can be present in an amount of from 1% by weight to 85% by weight, from 10% by weight to 85% by weight, from 15% by weight to 75% by weight or from 15% by weight to 65% by weight, based on the total weight of the coating composition. The coating compositions can include surface treated pigment and a combination of untreated mineral fillers and pigments in weight ratios of 90:10, 80:20, 70:30, 60:40, 50:50, 40:60, 30:70, 20:80 or 10:90. In some cases, the coating composition can include from 0.1% by weight to 90% by weight (e.g., from 1% by weight to 60% by weight, from 1% by weight to 55% by weight, from 1% by weight to 50% by weight, or from 5% by weight to 50% by weight) of surface treated pigment and/or untreated mineral fillers and/or pigments.

Examples of suitable pigment dispersing agents for use in the coating compositions are polyacid dispersants and hydrophobic copolymer dispersants. Polyacid dispersants are typically polycarboxylic acids, such as polyacrylic acid or polymethacrylic acid, which are partially or completely in the form of their ammonium, alkali metal, alkaline earth metal, ammonium, or lower alkyl quaternary ammonium salts. Polyacid dispersants include copolymers of acrylic acid, methacrylic acid, or maleic acid with hydrophobic monomers. In certain embodiments, the composition includes a polyacrylic acid-type dispersing agent, such as Pigment Disperser N, commercially available from BASF SE.

Examples of suitable thickeners include hydrophobically modified ethylene oxide urethane (HEUR) polymers, hydrophobically modified alkali soluble emulsion (HASE) polymers, hydrophobically modified hydroxyethyl celluloses (HMHECs), hydrophobically modified polyacrylamide, and combinations thereof. HEUR polymers are linear reaction products of diisocyanates with polyethylene oxide end-capped with hydrophobic hydrocarbon groups. HASE polymers are homopolymers of (meth)acrylic acid, or copolymers of (meth)acrylic acid, (meth)acrylate esters, or maleic acid modified with hydrophobic vinyl monomers. HMHECs include hydroxyethyl cellulose modified with hydrophobic alkyl chains. Hydrophobically modified polyacrylamides include copolymers of acrylamide with acrylamide modified with hydrophobic alkyl chains (N-alkyl acrylamide). In certain embodiments, the coating composition includes a hydrophobically modified hydroxyethyl cellulose thickener. Other suitable thickeners that can be used in the coating compositions can include acrylic copolymer dispersions sold under the STEROCOLL™ and LATEKOLL™ trademarks from BASF Corporation, Florham Park, N.J.; urethanes thickeners sold under the RHEOVIS™ trademark (e.g., Rheovis PU 1214); hydroxyethyl cellulose; guar gum; carrageenan; xanthan; acetan; konj ac; mannan; xyloglucan; and mixtures thereof. The thickeners can be added to the composition compositions as an aqueous dispersion or emulsion, or as a solid powder.

Suitable coalescing aids, which aid in film formation during drying, include ethylene glycol monomethyl ether, ethylene glycol monobutyl ether, ethylene glycol monoethyl ether acetate, ethylene glycol monobutyl ether acetate, diethylene glycol monobutyl ether, diethylene glycol monoethyl ether acetate, dipropylene glycol monomethyl ether, propylene glycol n-butyl ether, dipropylene glycol n-butyl ether, 2,2,4-trimethyl-1,3-pentanediol monoisobutyrate, or combinations thereof. In some embodiments, the coating compositions can include one or more coalescing aids such as propylene glycol n-butyl ether and/or dipropylene glycol n-butyl ether. The coalescing aids, if present, can be present in an amount of from greater than 0% to 30%, based on the dry weight of the polymer binder. For example, the coalescing aid can be present in an amount of from 10% to 30%, from 15% to 30% or from 15% to 25%, based on the dry weight of the polymer binder. In some embodiments, the coalescing aid can be included in coating compositions comprising a high Tg polymer binder (that is a polymer having a Tg greater than ambient temperature (e.g., 20° C.)). In these embodiments, the coalescing aid can be present in an effective amount to provide coating compositions having a Tg less than ambient temperature (e.g., 20° C.). In some embodiments, the compositions do not include a coalescing aid.

Defoamers serve to minimize frothing during mixing and/or application of the coating compositions. Suitable defoamers include organic defoamers such as mineral oils, silicone oils, and silica-based defoamers. Exemplary silicone oils include polysiloxanes, polydimethylsiloxanes, polyether modified polysiloxanes, or combinations thereof. Exemplary defoamers include BYK®-035, available from BYK USA Inc., the TEGO® series of defoamers, available from Evonik Industries, the DREWPLUS® series of defoamers, available from Ashland Inc., and FOAMASTER® NXZ, available from BASF Corporation.

Plasticizers can be added to the coating compositions to reduce the glass transition temperature (T_{g}) of the compositions below that of the drying temperature to allow for good film formation. Suitable plasticizers include diethylene glycol dibenzoate, dipropylene glycol dibenzoate, tripropylene glycol dibenzoate, butyl benzyl phthalate, or a combination thereof Exemplary plasticizers include phthalate-based plasticizers. The plasticizer can be present in an amount of from 1% to 15%, based on the dry weight of the polymer binder system. For example, the plasticizer can be present in an amount of from 5% to 15% or from 7% to 15%, based on the dry weight of the polymer binder system. In some embodiments, the plasticizer can be present in an effective amount to provide coating compositions having a Tg less than ambient temperature (e.g., 20° C.). In some embodiments, the compositions do not include a plasticizer.

Suitable surfactants include nonionic surfactants and anionic surfactants. Examples of nonionic surfactants are alkylphenoxy polyethoxyethanols having alkyl groups of about 7 to about 18 carbon atoms and having from about 6 to about 60 oxyethylene units; ethylene oxide derivatives of long chain carboxylic acids; analogous ethylene oxide condensates of long chain alcohols, and combinations thereof. Exemplary anionic surfactants include ammonium, alkali metal, alkaline earth metal, and lower alkyl quaternary ammonium salts of sulfosuccinates, higher fatty alcohol sulfates, aryl sulfonates, alkyl sulfonates, alkylaryl sulfonates, and combinations thereof. In certain embodiments, the composition comprises a nonionic alkylpolyethylene glycol surfactant, such as LUTENSOL® TDA 8 or LUTENSOL® AT-18, commercially available from BASF SE. In certain embodiments, the composition comprises an anionic alkyl ether sulfate surfactant, such as DISPONIL® FES 77, commercially available from BASF SE. In certain embodiments, the composition comprises an anionic diphenyl oxide disulfonate surfactant, such as CALFAX® DB-45, commercially available from Pilot Chemical.

Examples of suitable pH modifying agents include bases such as sodium hydroxide, potassium hydroxide, amino alcohols, monoethanolamine (MEA), diethanolamine (DEA), 2-(2-aminoethoxy)ethanol, diisopropanolamine (DIPA), 1-amino-2-propanol (AMP), ammonia, and combinations thereof. In some embodiments, the compositions do not include an ammonia-based pH modifier. The pH of the dispersion can be greater than 7. For example, the pH can be 7.5 or greater, 8.0 or greater, 8.5 of greater, or 9.0 or greater.

Suitable biocides can be incorporated to inhibit the growth of bacteria and other microbes in the coating composition during storage. Exemplary biocides include 2-[(hydroxymethyl)amino]ethanol, 2-[(hydroxymethyl) amino]2-methyl-1-propanol, o-phenylphenol, sodium salt, 1,2-benzisothiazolin-3-one, 2-methyl-4-isothiazolin-3-one (MIT), 5-chloro2-methyland-4-isothiazolin-3-one (CIT), 2-octyl-4-isothiazolin-3-one (OIT), 4,5-dichloro-2-n-octyl-3-isothiazolone, as well as acceptable salts and combinations thereof Suitable biocides also include biocides that inhibit the growth of mold, mildew, and spores thereof in the coating. Examples of mildewcides include 2-(thiocyanomethylthio)-benzothiazole, 3-iodo-2-propynyl butyl carbamate, 2,4,5,6-tetrachloroisophthalonitrile, 2-(4-thiazolyl)benzimidazole, 2-N-octyl4-isothiazolin-3-one, diiodomethyl p-tolyl sulfone, as well as acceptable salts and combinations thereof. In certain embodiments, the coating composition contains 1,2-benzisothiazolin-3-one or a salt thereof. Biocides of this type include PROXEL® BD20, commercially available from Arch Chemicals, Inc. The biocide can alternatively be applied as a film to the coating and a commercially available film-forming biocide is Zinc Omadine® commercially available from Arch Chemicals, Inc.

Exemplary co-solvents and humectants include ethylene glycol, propylene glycol, diethylene glycol, and combinations thereof. Exemplary dispersants can include sodium polyacrylates in aqueous solution such as those sold under the DARVAN trademark by R.T. Vanderbilt Co., Norwalk, Conn.

The coating compositions can be used for several applications, including in architectural coatings such as an architectural paint, industrial coatings, or inks, which are further discussed herein. In some examples, the coating compositions can be provided as a paint, such as an aqueous based paint, a semi-gloss paint, or a high gloss paint. Generally, coatings are formed by applying the coating composition as described herein to a surface, and allowing the coating to dry (that is, removal of 95% by weight or greater, such as from 95% to 99% by weight of volatiles) to form a dried coating, such as a film. The surface can be, for example, wood, glass, metal, wood, plastic, asphalt, concrete, ceramic material or another coating layer applied on such a surface. Specific surfaces include wall, PVC pipe, brick, mortar, carpet, granule, pavement, ceiling tile, sport surface, exterior insulation and finish system (EIFS), polyurethane foam surface, polyolefin surface, ethylene-propylene diene monomer (EPDM) surface, roof, vinyl, and another coating surface (in the case of recoating applications).

The coating composition can be applied to a surface by any suitable coating technique, including spraying, rolling, brushing, or spreading. The composition can be applied in a single coat, or in multiple sequential coats (e.g., in two coats or in three coats) as required for a particular application. Generally, the coating composition is allowed to dry under ambient conditions. However, in certain embodiments, the coating composition can be dried, for example, by heating and/or by circulating air over the coating.

The thickness of the resultant coating compositions can vary depending upon the application of the coating. For example, the coating can have a dry thickness of at least 0.5 microns, (e.g., at least 10 microns, at least 15 microns, at least 20 microns, at least 25 microns, at least 30 microns, at least 40 microns, at least 50 microns, at least 60 microns, at least 75 microns, at least 85 microns, at least 100 microns, at least 150 microns, at least 200 microns, at least 250 microns, at least 300 microns, at least 350 microns, at least 400 microns, at least 450 microns, or at least 500 microns. In some instances, the coating compositions has a dry thickness of less than 500 microns (e.g., 450 microns or less, 400 microns or less, 350 microns or less, 300 microns or less, 250 microns or less, 200 microns or less, 150 microns or less, 100 microns or less, 75 microns or less, 50 microns or less, 40 microns or less, 30 microns or less, 25 microns or less, or 20 microns or less. In some embodiments, the coating compositions has a dry thickness of between 0.5 microns and 500 microns, from 0.5 microns to 250 microns, from 0.5 microns to 75 microns, or from 5 microns to 75 microns.

As described herein, the coating compositions when dried, can exhibit stain and dirt resistance. In some embodiments, the coatings can exhibit an improved stain and dirt resistance to lipstick, washable marker, and highlighter stains, coffee, mustard, ketchup, ink, juice, wine, or combinations thereof compared to an identical formulation comprising untreated mineral pigment, as determined by ASTM D 4828-94. The coatings can exhibit an improved stain resistance to both hydrophobic and hydrophilic stains.

Stain and/or dirt produce an observable color change on a film. Thus, stain measurements can be made using an X-Rite Pantone model SP62 chroma meter. The color change, ΔE of a stained control film (formed from aqueous coating comprising untreated pigment) and treated film (formed from aqueous coating comprising a surface treated pigment) can be made according to ASTM D2244-16. In some embodiments, the color of a stain and/or dirt on the treated film is reduced by a ΔE value 0.1 or greater, compared to an identical film formed from the untreated pigment, as determined by ASTM D 4828-94. The stain and/or dirt can be hydrophobic of hydrophilic, such as lipstick, highlighter, coffee, grape juice, or red wine. For example, the color of the stain and/or dirt on the treated film can be reduced by a ΔE value greater than 0.1, greater than 0.15, greater than 0.20, greater than 0.25, greater than 0.30, greater than 0.40, greater than 0.50, greater than 0.60, greater than 0.75, greater than 0.80, greater than 0.90, greater than 1.0, greater than 1.5, greater than 2.0, greater than 2.5, from 0.01 to 3.0, from 0.01 to 2.6, from 0.01 to 2.5, from 0.5 to 2.6, or from 0.5 to 2.2, compared to the color on an identical film formed from an untreated pigment. In some embodiments, the treated film can exhibit a total color change value, ΔE, from 0 to less than 10, from 0 to 9, from 0 to 8, from 0.5 to 8, from 0.5 to 6, from 0.5 to 5, or from 0 to less than 5, after 1 hour of contact with the stain and/or dirt. In some embodiments, after 1 hour of contact with a stain and/or dirt, the treated film can exhibit a color change, ΔE, less than 50%, less than 45%, less than 40%, less than 35%, less than 30%, less than 25%, less than 20%, less than 15%, or less than 10%, compared to the color change of an identical film formed from an untreated pigment.

In specific embodiments, the color of a hydrophilic stain (such as highlighter, coffee, grape juice, or red wine) on the treated film can be reduced by a ΔE value of 0.1 or greater, greater than 0.15, greater than 0.20, greater than 0.25, greater than 0.30, greater than 0.40, greater than 0.50, greater than 0.60, greater than 0.75, greater than 0.80, greater than 0.90, greater than 1.0, greater than 1.5, greater than 2.0, greater than 2.5, from 0.01 to 3.0, from 0.01 to 2.6, from 0.01 to 2.5, from 0.5 to 2.6, or from 0.5 to 2.2, compared to the color on an identical film formed from an untreated pigment. In some embodiments, the treated film can exhibit a total color change value, ΔE, of from 0 to less than 10, from 1 to 10, from 1 to 9, from 1 to 8, from 1 to 7, from 2 to 10, from 2 to 9, from 2 to 8, or from 2 to 7, after 1 hour of contact with a hydrophilic stain (such as highlighter, coffee, grape juice, or red wine). In some embodiments, after 1 hour of contact with a hydrophilic stain (such as highlighter, coffee, grape juice, or red wine), the treated film can exhibit a color change, ΔE, less than 50%, less than 45%, less than 40%, less than 35%, less than 30%, less than 25%, less than 20%, less than 15%, or less than 10%, compared to the color change of an identical film formed from an untreated pigment.

In specific embodiments, the color of a hydrophobic stain (such as lipstick) on the treated film can be reduced by a ΔE value of 0.1 or greater, greater than 0.15, greater than 0.20, greater than 0.25, greater than 0.30, greater than 0.40, greater than 0.50, greater than 0.60, or greater than 0.75, compared to the color on an identical film formed from an untreated pigment. In some embodiments, the treated film can exhibit a total color change value, ΔE, from 0 to less than 10, from 1 to 10, from 1 to 9.5, from 2 to 10, from 2 to 9.5, or from 3 to 10, after 1 hour of contact with a hydrophobic stain (such as lipstick). In some embodiments, after 1 hour of contact with a hydrophobic stain (such as lipstick), the treated film can exhibit a color change, ΔE, of less than 50%, less than 45%, less than 40%, less than 35%, less than 30%, less than 25%, less than 20%, less than 15%, or less than 10%, compared to the color change of an identical film formed from an untreated pigment.

The coatings can exhibit improved oil barrier properties, water barrier properties, oil and water barrier properties, and/or solvent barrier properties, as determined by ASTM D 4828-94.

Methods

Methods of making and using the surface treated pigment are described herein. The method of producing the surface treated pigment can include mixing a mineral pigment with a hydrophilic latex composition and a hydrophobic material under conditions to surface treat the mineral pigment. As described herein, at least one of the hydrophilic latex composition and the hydrophobic material produces a film on an outer surface of the mineral pigment.

In some embodiments, the hydrophilic latex composition and the hydrophobic material are blended prior to mixing with the mineral pigment. In other embodiments, the hydrophilic latex composition and the hydrophobic material are mixed with the mineral pigment sequentially, in an order.

The mineral pigment can be provided in a dry form such as a powder or as a slurry. The hydrophobic material can be provided as a neat mixture, for example, a neat silane, neat siloxane, or mixtures thereof. Alternately, the hydrophobic material can be provided as an emulsion, for example, a silane emulsion, a siloxane emulsion, or a mixture thereof.

Mixing the mineral pigment with the hydrophilic latex composition and the hydrophobic material under conditions to surface treat the mineral pigment can be carried out with a blender or a centrifuge. Mixing can be for at least 2 minutes, at least 5 minutes, at least 10 minutes, at least 15 minutes, at least 20 minutes, at least 25 minutes, or at least 30 minutes.

The mixture comprising mineral pigment, the hydrophilic latex composition and/or the hydrophobic material can be dried by heating.

Methods of producing aqueous coating systems from the surface treated pigments are also described. The method of producing the aqueous coating system can comprise mixing the surface treated pigment and a polymer binder system to form the aqueous coating system. The aqueous coating system can further include an untreated mineral pigment. Such aqueous coating systems can be selected from any coating such as a paint, an ink, or an adhesive.

Methods for improving the stain and/or dirt resistance properties of a surface comprising applying the aqueous coating system to the surface are disclosed. The surface can be a fabric, a fiber, a carpet, a concrete, a wood, a vinyl, a leather, a metal, a plastic, a ceramic, or a paper.

By way of non-limiting illustration, examples of certain embodiments of the present disclosure are given below.

### EXAMPLES

### Example 1

### Preparation of Surface Treated Pigment

Dynasylan 6598 (a vinyl-alkyl siloxane oligomer from Evonik) was slowly added to calcined kaolin (Mattex PRO from BASF Corporation) as described in Table 1. The siloxane component and the calcined kaolin were mixed for 40 minutes. Silane treated kaolin was obtained. The silane treated kaolin was mixed with Joncryl 3030 (an acrylic emulsion form BASF) as described in Table 1. The Joncryl 3030 component and the silane treated kaolin were mixed for 40 minutes in a ribbon blender. The combined amount of silane and Joncryl 3030 used for surface treatment was 1% by weight of dry kaolin. Surface treated kaolin was obtained.

TABLE 1
Surface treated kaolin

| | Dynasylan 6598 | Joncryl 3030 |
|---|---|---|
| Sample | (% by weight | (% by weight |
| Name | surface treatment) | surface treatment) |
| Sample 221 | 0 | 100 |
| Sample 222 | 20 | 80 |
| Sample 223 | 40 | 60 |
| Sample 224 | 80 | 20 |
| Sample 225 | 100 | 0 |
| Sample 226 | 0 | 0 |

Preparation of paint formulation: In the grind stage, the surface treated kaolin obtained above was dispersed with TiO₂, another pigment, various paint additives and water, as described in Table 2 below, in a mill under high shear conditions for 18 to 20 minutes to form a grind paste. Further, the agitation speed was slowed and water was added. Subsequently, Acrysol SG 30 (a non-commercial latex binder) was added to the grind paste. Finally, additional components were added to obtain the desired paint formulation (see Table 2 below for the weight percentages).

TABLE 2
Paint Formulations

| Raw Material | Example A | Example B | Example C |
|---|---|---|---|
| Water | 137.2 | 137.2 | 82.0 |
| Ethylene Glycol | 19.4 | 19.4 | 11.6 |
| Tamol 731 | 4.2 | 4.3 | 2.6 |
| Tamol 165A | 6.0 | 6.1 | 3.6 |
| AMP 95 | 0.4 | 0.5 | 0.3 |
| Triton CF 10 | 2.7 | 2.7 | 1.6 |
| Aquaflow NHS 310 | 18.9 | 18.9 | 11.3 |
| Drew Plus T4507 | 0.9 | 0.9 | 0.5 |
| TiO2 2310 | 213.4 | 213.4 | 127.5 |
| Mattex PRO | 132.8 | 132.8 | 79.4 |
| Minex 4 | 97.7 | 97.7 | 58.4 |
| Attagel 50 | 2.7 | 2.7 | 1.6 |
| Grind 18-20 min./Then lower speed for Let Down | | | |
| Water | 75.4 | 75.4 | 45.0 |
| Lower speed | | | |
| for latex | | | |
| Acrysol SG 30 | 292.4 | 292.4 | 174.7 |
| Velate 368 | 12.1 | 12.1 | 7.2 |
| Ropaque Ultra | 37.2 | 37.2 | 22.2 |
| Proxel DL | 1.1 | 1.1 | 0.7 |
| Drew Plus T4507 | 2.7 | 2.6 | 1.6 |
| Acrysol RM 12W | 1.3 | 1.3 | 0.8 |
| Acrysol SCT 275 | 2.1 | 2.1 | 1.3 |
| Total | 1060.6 | 1060.6 | 633.9 |

The amounts of each raw material are given in volume amount.

Stain Resistance Test:

Paint formulations comprising Samples 221, 222, 223, 224, and 225 were drawn down to be tested side-by-side with a suitable control (Sample 226) using the 7 mil blade of a Dow Film Caster lengthwise on a vinyl scrub chart.

All panels were air dried for approximately 7 days under a temperature of 25° C. (77° F.) and 50% of relative humidity.

The required stains (lipstick, black washable marker, black pen, highlighter, mustard, ketchup, coffee and grape juice stains) were applied perpendicular to that of test paint approximately equal in width (a template with spacers is generally used).

The staining media was left on the coating for approximately 1 hour.

The panels were rinsed with water under the tap thoroughly to remove excess stain (and blot dried if necessary).

The glass panels were turned so that the smooth side is up. Then, the test panels were placed in the scrub machine tray on top of the glass and secure.

The sponge and holder were prepared by rinsing the sponge under running water until saturated and the sponge was squeezed to remove any excess water.

With a syringe, approximately 10 CC of Leneta SC-1 (Standardized Scrub Medium Non-Abrasive type) were measured and the medium was placed on the sponge, run for 25 cycles.

After 25 cycles, it was stopped. The sponge was flipped to the other side, another 5 cc of SC-1 were added and it was run for another 25 cycles. Note: it is permissible to reuse sponges if they are not excessively soiled or damaged.

The test panels were removed, rinsed with water and blot dried.

Each applied stain was then rated visually versus a control, i.e. Sample 226 as shown in Table 3.

Sample 225 appeared to be less dusty (similar to the control, Sample 226) than the other samples.

TABLE 3
Stain Resistance

| | | | | | | |
|---|---|---|---|---|---|---|
| Flat Formula | | | | | | |
| Properties | 226 CTL | 221 | 222 | 223 | 224 | 225 |
| Kui | 86 | 86 | 85 | 86 | 88 | 86 |
| KUe | 102 | 102 | 100 | 102 | 101 | 98 |
| Contrast Ratio 3 mils: | 97.8 | 97.9 | 97.7 | 97.8 | 97.8 | 97.5 |
| Brightness: | 88.67 | 88.44 | 88.63 | 88.60 | 88.47 | 88.44 |
| Whiteness: | 84.26 | 84.26 | 84.28 | 84.33 | 84.14 | 84.12 |
| Yellowness: | 1.43 | 1.35 | 1.42 | 1.37 | 1.41 | 1.40 |
| Hunter L: | 95.93 | 95.81 | 95.92 | 95.90 | 95.85 | 95.83 |
| Hunter a: | −0.86 | −0.85 | −0.86 | −0.86 | −0.87 | −0.88 |
| Hunter b: | 1.34 | 1.28 | 1.33 | 1.30 | 1.33 | 1.33 |
| Gloss @ 20 deg: | 1.4 | 1.5 | 1.5 | 1.5 | 1.5 | 1.4 |
| Gloss @ 60 deg: | 2.7 | 2.8 | 3.0 | 3.1 | 3.0 | 2.9 |
| Sheen @ 85 deg: | 2.3 | 2.5 | 2.7 | 2.8 | 2.4 | 2.1 |
| Stain Resistance Vs. | 226 Stain Ctl | 221 | 222 | 223 | 224 | 225 |
| Lipstick | CTL | slight worse | better | slight better | slight worse | slight worse |
| Black Washable Marker | CTL | slight better | slight better | slight better | slight better | slight better |
| Pen - Black | CTL | = | = | = | = | = |
| Highlighter | CTL | = | better | better | better | much better |
| Mustard | CTL | = | slight better | slight better | slight better | better |
| Ketchup | CTL | = | = | better | slight better | better |
| Coffee | CTL | = | slight better | better | better | better |
| Grape Juice | CTL | = | better | better | much better | much better |
| Red Wine | CTL | = | better | much better | slight better | much better |

Stain Resistance Determined Using an X-Rite Pantone Model SP62 Chroma Meter:

The ΔE values of the samples prepared from Table 3 were determined using ASTM D2244-16 and outlined in Table 4.

TABLE 4
ΔE values

| Stain | ID | ΔE | ID | ΔE | ID | ΔE | ID | ΔE | ID | ΔE |
|---|---|---|---|---|---|---|---|---|---|---|
| Lipstick | 226 | 1.35 | 226 | 9.95 | 226 | 9.62 | 226 | 4.18 | 226 | 4.32 |
| | 221 | 1.21 | 222 | 9.20 | 223 | 9.71 | 224 | 4.36 | 225 | 4.05 |
| | Diff. | 0.14 | Diff. | 0.75 | Diff. | −0.09 | Diff. | −0.18 | Diff. | 0.27 |
| Highlighter | 226 | 2.21 | 226 | 5.07 | 226 | 3.90 | 226 | 5.04 | 226 | 4.83 |
| | 221 | 1.76 | 222 | 3.32 | 223 | 2.12 | 224 | 2.58 | 225 | 2.41 |
| | Diff. | 0.45 | Diff. | 1.75 | Diff. | 1.78 | Diff. | 2.46 | Diff. | 2.42 |
| Coffee | 226 | 5.91 | 226 | 6.66 | 226 | 6.11 | 226 | 6.65 | 226 | 6.47 |
| | 221 | 5.35 | 222 | 5.51 | 223 | 4.35 | 224 | 4.61 | 225 | 4.45 |
| | Diff. | 0.56 | Diff. | 1.15 | Diff. | 1.76 | Diff. | 2.04 | Diff. | 2.02 |
| Grape Juice | 226 | 2.93 | 226 | 3.34 | 226 | 4.35 | 226 | 2.62 | 226 | 2.59 |
| | 221 | 2.85 | 222 | 3.20 | 223 | 2.61 | 224 | 1.42 | 225 | 1.34 |
| | Diff. | 0.08 | Diff. | 0.14 | Diff. | 1.74 | Diff. | 1.20 | Diff. | 1.25 |
| Red Wine | 226 | 2.38 | 226 | 2.47 | 226 | 2.13 | 226 | 2.07 | 226 | 2.21 |
| | 221 | 2.15 | 22 | 1.91 | 223 | 1.37 | 224 | 1.24 | 225 | 1.29 |
| | Diff. | 0.23 | Diff. | 0.56 | Diff. | 0.76 | Diff. | 0.83 | Diff. | 0.92 |

Wet-out rates: The wetting rates of the pigments were investigated by adding (by floating) the pigment to a beaker with water without stirring. Wetting of the pigments were visually observed. The turbidity of each sample was determined after standing for up to two hours.

TABLE 5
Turbidity Measurements

| | | | | | | |
|---|---|---|---|---|---|---|
| Sample | 221 | 222 | 223 | 224 | 225 | 226 |

Wet Out Rate (5 gm/100 ml DI H20)

| | | | | | | |
|---|---|---|---|---|---|---|
| min:sec | 4. | 120 | 120 | 120 | 120 | 0.1 |
| Turbidity of DI H20 | 0.2 | 0.23 | 0.22 | 0.23 | 0.23 | 0.26 |

Turbidity @ 0.1% ratio clay to H20

| | | | | | | |
|---|---|---|---|---|---|---|
| NTU/1 min settle (A) | 485 | 0.74 | 0.38 | 0.59 | 0.61 | 918 |
| Turbidity @ DI H20 | 0.31 | 0.335 | 0.33 | 0.335 | 0.335 | 0.26 |
| NTU/1 min settle (B) | 231 | 1.53 | 0.93 | 0.59 | 0.42 | 906 |
| Turbidity @ DI H20 | 0.3 | 0.315 | 0.3 | 0.26 | 0.28 | 0.26 |
| NTU/1 min settle (C) | 376 | 0.77 | 0.68 | 0.57 | 0.43 | 814 |
| Average Turbidity (3 sets) | 364 | 1.02 | 0.66 | 0.58 | 0.49 | 879 |

Results: Table 5 summarizes the turbidity measurements. The untreated Matter PRO pigment (sample 226) exhibited complete wetting by water within 7 seconds of adding to water. Sample 226 formed a suspension with water. Sample 221 exhibited very little settling after 60 seconds of adding to water. Most of Sample 221 floated on top of the water. Samples 222-225 exhibited no settling after 60 seconds of adding to water. All of Samples 222-225 floated on top of the water.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments and are also disclosed.

As used in this disclosure and in the appended claims, the singular forms “a”, “an”, “the”, include plural referents unless the context clearly dictates otherwise. The disclosure of percentage ranges and other ranges herein includes the disclosure of the endpoints of the range and any integers provided in the range.

Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

1. A surface treated pigment comprising:
a mineral pigment surface treated with a hydrophilic latex composition selected from a straight (meth)acrylic latex emulsion, a styrene-(meth)acrylic latex emulsion, or a blend thereof, and a hydrophobic material selected from a silane, a siloxane, or a siloxane/silicone resin blend, wax, fatty acid, styrene-butadiene latex, or a mixture thereof;
wherein at least one of the hydrophilic latex composition and the hydrophobic material produces a film on an outer surface of the mineral pigment, and
wherein the surface treated pigment has a surface energy that is less than a surface energy of the mineral pigment alone.

2. The surface treated pigment of claim 1, wherein the difference between the surface energy of the surface treated pigment and the surface energy of the mineral pigment is 1 mN/m or greater, or from 1 mN/m to 5 mN/m.

3. The surface treated pigment of claim 1, wherein the surface energy of the surface treated pigment is less than a surface energy of a mineral pigment treated with the hydrophilic latex composition alone.

4. The surface treated pigment of claim 3, wherein the difference between the surface energy of the surface treated pigment and the surface energy of the mineral pigment treated with the hydrophilic latex composition alone is 0.2 mN/m or greater, or from 0.2 mN/m to 2 mN/m.

5. The surface treated pigment of claim 1, wherein the surface energy of the surface treated pigment is less than a surface energy of a mineral pigment treated with the hydrophobic material alone.

6. The surface treated pigment of claim 5, wherein the difference between the surface energy of the surface treated pigment and the surface energy of the mineral pigment treated with the hydrophobic material alone is 0.2 mN/m or greater, or from 0.2 mN/m to 2 mN/m.

7. The surface treated pigment of claim 1, wherein the surface treated pigment has a surface energy of less than 20 mN/m, or from 10 to 18 mN/m.

8. The surface treated pigment of claim 1, wherein a surface of the surface treated pigment exhibits a water contact angle of at least 90° and a dodecane contact angle of less than 150° or less than 90°.

9. The surface treated pigment of claim 8, wherein both the water contact angle and the dodecane contact angle of the surface treated pigment are higher than a water contact angle and a dodecane contact angle of the mineral pigment.

10. The surface treated pigment of claim 8, wherein both the water contact angle and the dodecane contact angle of the surface treated pigment are higher than a water contact angle and a dodecane contact angle of a mineral pigment treated with the hydrophobic material alone.

11. The surface treated pigment of claim 8, wherein the water contact angle of the surface treated pigment is less than a water contact angle of a mineral pigment treated with the hydrophilic latex composition alone and the dodecane contact angle of the surface treated pigment is greater than a dodecane contact angle of a mineral pigment treated with the hydrophilic latex composition alone.

12. The surface treated pigment of claim 1, wherein the surface treated pigment is less wettable by water, compared to the mineral pigment or a mineral pigment treated with the hydrophilic latex composition alone, as determined by ASTM 7315-17.

13. The surface treated pigment of claim 12, wherein a mixture comprising the surface treated pigment in contact with water for a period of at least 120 minutes, has a turbidity of 1.5 NTU or less, or 1.0 NTU or less.

14. The surface treated pigment of claim 1, wherein the mineral pigment is calcined prior to surface treatment.

15. The surface treated pigment of claim 1, wherein the mineral pigment is selected from the group consisting of kaolin, bentonite, mica, talc, attapulgite, silica, calcium carbonate, halloysite, wollastonite, nepheline syenite, feldspar, diatomaceous earth, and zeolite.

16. The surface treated pigment of claim 15, wherein the mineral pigment includes kaolin, preferably calcined kaolin.

17. The surface treated pigment of claim 1, wherein the mineral pigment has an average particle size of less than 10 microns, preferably an average particle size ranging from 0.1 to 10 microns, more preferably an average particle size ranging from 0.1 to 2 microns.

18. The surface treated pigment of claim 1, wherein the hydrophobic material includes an organosilane monomer having a structure defined by the general Formula I below:
(R¹)—(Si)—(R²)₃ (I)
wherein R¹ is a C₁-C₈ substituted or unsubstituted alkyl or a C₂-C₈ substituted or unsubstituted alkene and each of R² is independently a C₁-C₈ substituted or unsubstituted alkyl group, a C₁-C₈ substituted or unsubstituted alkoxy group, or a combination thereof.

19. The surface treated pigment of claim 1, wherein the hydrophobic material includes an oligomeric or polymeric siloxane.

20. The surface treated pigment of claim 1, wherein the hydrophobic material includes vinyltrimethoxysilane, vinyltriethoxysilane, vinyl tris(2-methoxyethoxy silane), vinyl triisopropoxysilane, gamma-methacryloxypropyl trimethoxysilane, (3-methacryloxypropyl)-trimethoxysilane, (3-methacryloxypropyl)-triethoxysilane, (3-methacryloxypropyl)-triisopropoxysilane, 2-methyl-2-propenoic acid 3-[tris-(1-methylethoxy)-silyl]-propyl ester, (3-methacryloxypropyl)-methyldiethoxysilane, 3-glycidoxypropyl methyldiethoxysilane, 3-glycidoxypropyl methyldimethoxysilane, oligomers thereof, polymers thereof, or combinations thereof.

21. The surface treated pigment of claim 1, wherein the hydrophilic latex composition comprises a straight (meth)acrylic latex emulsion.

22. The surface treated pigment of claim 21, wherein the straight (meth)acrylic latex emulsion comprises a copolymer derived from monomers comprising 80% or greater, preferably from 80% to less than 100% by weight of a (meth)acrylate monomer.

23. The surface treated pigment of claim 1, wherein the hydrophilic latex composition comprises a styrene-(meth)acrylic latex emulsion.

24. The surface treated pigment of claim 23, wherein the styrene-(meth)acrylic latex emulsion comprises a copolymer derived from monomers comprising 20% to 80% by weight of styrene and 20% to 80% by weight of a (meth)acrylate monomer.

25. The surface treated pigment of claim 21, wherein the copolymer present in the straight (meth)acrylic latex emulsion or the styrene-(meth)acrylic latex emulsion is further derived from one or more additional monomers that include carboxylic acid monomers, crosslinkable functional monomers, (meth)acrylamide, or mixtures thereof.

26. The surface treated pigment of claim 21, wherein the copolymer present in the straight (meth)acrylic latex emulsion or the styrene-(meth)acrylic latex emulsion has a glass transition temperature of 30° C. or less, preferably from −60° C. to 30° C., more preferably from −40° C. to less than 0° C.

27. The surface treated pigment of claim 1, wherein the mineral pigment is surface treated with a straight (meth)acrylic latex emulsion as the hydrophilic latex composition and a silane as the hydrophobic material.

28. The surface treated pigment of claim 1, wherein the hydrophilic latex composition and the hydrophobic material are in a weight ratio of from 1:4 to 4:1, from 1:3 to 3:1, preferably from 1:2 to 2:1.

29. The surface treated pigment of claim 1, wherein the surface treated pigment comprises 0.2% by weight or greater, preferably from 0.2% to 5% by weight, more preferably from 0.5% to 2% by weight of the hydrophilic latex composition and the hydrophobic material, based on the weight of the surface treated pigment.

30. An aqueous coating system comprising a surface treated pigment according to claim 1.

31. The aqueous coating system of claim 30, comprising at least 0.2% by weight, preferably from 0.2% to 30% by weight, more preferably from 0.5% to 10% by weight of the surface treated pigment.

32. The aqueous coating system of claim 30, further comprising a polymer binder system.

33. The aqueous coating system of claim 32, comprising at least 10% by weight, preferably from 10% to 99% by weight, more preferably from 10% to 95% by weight of the polymer binder system.

34. The aqueous coating system of claim 32, wherein the polymer binder system comprises a latex polymer binder.

35. The aqueous coating system of claim 34, wherein the latex polymer binder comprises a polymer or copolymer derived from synthetic resins, natural resins, (meth)acrylics, polyurethanes, polyesters including unsaturated and saturated polyesters, melamine polymers, epoxy polymers, alkyds, phenolic polymers, ureaformaldehyde polymers, polyalkylenes including polyethylenes and polypropylenes, polystyrenes, polyamides, polyvinyl compounds, polyisoprenes, polybutadienes, polystyrene butadienes, or a combination thereof.

36. The aqueous coating system of claim 30, further comprising an untreated mineral pigment.

37. The aqueous coating system of claim 36, wherein the untreated mineral pigment is selected from titanium dioxide, clay, kaolin, mica, talc, natural silica, synthetic silica, natural silicates, synthetic silicates, feldspars, nepheline syenite, wollastonite, diatomite, barite, glass, calcium carbonate, or combinations thereof.

38. The aqueous coating system of claim 30, wherein the aqueous coating system is a paint or and ink.

39. The aqueous coating system of claim 30, wherein the aqueous coating system is an adhesive.

40. The aqueous coating system of claim 30, wherein the substrate is a fabric, a fiber, a carpet, a concrete, a wood, a vinyl, a leather, a metal, a plastic, a ceramic, or a paper.

41. A treated film derived from an aqueous coating system of claim 30, wherein the treated film exhibits stain and/or dirt resistance properties, wherein the stain and/or dirt produce a color change on a film, and wherein the color change of the treated film is reduced by a ΔE value of 0.1 or greater, greater than 0.1, or greater than 0.2 compared to the identical film formed from the untreated pigment, as determined by ASTM D2244-16.

42. The treated film of claim 41, wherein the treated film exhibits a total color change value, ΔE, of from 0 to less than 10, or from 0 to less than 5, after 1 hour of contact with the stain and/or dirt, as determined by ASTM D2244-16.

43. The treated film of claim 41, wherein the treated film exhibits stain resistance properties to both hydrophobic and hydrophilic stains.

44. The treated film of claim 41, wherein the treated film further exhibits oil barrier properties, water barrier properties, oil and water barrier properties, and/or solvent barrier properties, as determined by ASTM D 4828-94.

45. The treated film of claim 41, wherein the treated film exhibits resistance to coffee, mustard, ketchup, lipstick, ink, juice, wine, or combinations thereof.

46. The treated film of claim 41, having a thickness of at least 0.5 microns, preferably a thickness of from 0.5-150 microns.

47. A method of producing a surface treated pigment according to claim 1, comprising:
mixing a mineral pigment with a hydrophilic latex composition selected from a straight (meth)acrylic latex emulsion, a styrene-(meth)acrylic latex emulsion, or a blend thereof, and a hydrophobic material selected from a silane, a siloxane, or a siloxane/silicone resin blend, wax, fatty acid, styrene-butadiene latex, or a mixture thereof, under conditions to surface treat the mineral pigment with the composition,
wherein at least one of the hydrophilic latex composition and the hydrophobic material produces a film on an outer surface of the pigment, and
wherein the surface treated pigment has a surface energy that is less than a surface energy of the mineral pigment alone.

48. The method of claim 47, wherein the hydrophilic latex composition and the hydrophobic material are blended prior to mixing with the mineral pigment.

49. The method of claim 47, wherein the hydrophilic latex composition and the hydrophobic material are mixed with the mineral pigment sequentially.

50. The method of claim 47, wherein the mineral pigment is a calcined mineral pigment.

51. The method of claim 47, wherein the mineral pigment is provided as a powder.

52. The method of claim 47, wherein the mineral pigment provided as a slurry.

53. The method of claim 52, wherein the slurry is dried by heating after mixing with the hydrophilic latex composition and/or the hydrophobic material.

54. The method of claim 47, wherein the hydrophobic material comprises neat silane, neat siloxane, or mixtures thereof.

55. The method of claim 47, wherein the hydrophobic material comprises a silane emulsion, a siloxane emulsion, or a mixture thereof.

56. The method of claim 46, wherein mixing is carried out with a blender or a centrifuge for at least 30 minutes.

57. The method of claim 47, wherein the hydrophilic latex composition and the hydrophobic material are in a weight ratio of from 1:4 to 4:1, from 1:3 to 3:1, preferably from 1:2 to 2:1.

58. A method of producing an aqueous coating system comprising:
mixing a surface treated pigment according to claim 1 and a polymer binder system to form the aqueous coating system.

59. The method of claim 58, further comprising an untreated mineral pigment.

60. The method of claim 58, wherein the aqueous coating system is a paint or an ink.

61. A method for improving the stain and/or dirt resistance properties of a surface, the method comprising applying an aqueous coating system of claim 1 to the surface, wherein the aqueous coating system is a paint or ink.

62. The method of claim 61, wherein the surface is a fabric, a fiber, a carpet, a concrete, a wood, a vinyl, a leather, a metal, a plastic, a ceramic, or a paper.

63. The method of claim 61, wherein the aqueous coating system forms a treated film after drying, and wherein the treated film exhibits stain and/or dirt resistance properties, wherein the stain and/or dirt produce a color change on a film, and wherein the color change of the treated film is reduced by a ΔE value of 0.1 or greater, greater than 0.1, or greater than 0.2 compared to the identical film formed from the untreated pigment, as determined by ASTM D2244-16.

64. The method of claim 63, wherein the treated film exhibits a total color change value, ΔE, from 0 to less than 10, or from 0 to less than 5, after 1 hour of contact with the stain and/or dirt, as determined by ASTM D2244-16.

65. The method of claim 63, wherein the treated film exhibits stain resistance properties to both hydrophobic and hydrophilic stains.

66. The method of claim 63, wherein the treated film further exhibits oil barrier properties, water barrier properties, oil and water barrier properties, and/or solvent barrier properties, as determined by ASTM D 4828-94.

67. The method of claim 63, wherein the treated film exhibits resistance to coffee, mustard, ketchup, lipstick, ink, juice, wine, or combinations thereof.
